(19) United States
(12) Patent Application Publication
(10) Pub. No.: US 2025/0115055 A1
(43) Pub. Date: Apr. 10, 2025

(54) INK JET RECORDING METHOD

(71) Applicant: CANON KABUSHIKI KAISHA, Tokyo (JP)

(72) Inventors: FUMI TANAKA, Kanagawa (JP); YUGO YAMAMOTO, Kanagawa (JP); MIKIO SANADA, Kanagawa (JP); SHOICHI TAKEDA, Kanagawa (JP); YOSHIYUKI KANEKO, Kanagawa (JP); KOICHI ISHIDA, Tokyo (JP); SHUZO IWANAGA, Kanagawa (JP); SHINGO OKUSHIMA, Kanagawa (JP); SATOSHI KIMURA, Kanagawa (JP); YUMI KOMAMIYA, Kanagawa (JP); KYOSUKE TODA, Kanagawa (JP)

(21) Appl. No.: 18/906,888

(22) Filed: Oct. 4, 2024

(30) Foreign Application Priority Data
Oct. 6, 2023 (JP) 2023-173993

(51) Int. Cl. B41J 2/21; B41J 2/14; B41J 2/18; C09D 11/54

(52) U.S. Cl. CPC B41J 2/2114; B41J 2/14032; B41J 2/18; C09D 11/54; B41J 2202/12

(57) ABSTRACT

An ink jet recording method including ejecting an aqueous ink from a first ejection port, and ejecting, from a second ejection port, an aqueous reaction liquid containing a reactant that reacts with the aqueous ink. The liquid ejection apparatus includes an element substrate having the second ejection port configured to eject the aqueous reaction liquid, a pressure chamber, and an energy-generating element, an upstream channel r, and a downstream channe, and the element substrate has a face configured to face the record medium in an ejection direction of the aqueous reaction liquid, wherein the method further including ejecting the aqueous reaction liquid from the second ejection port which is located closer to the pressure chamber than the face, and flowing the aqueous reaction liquid from the upstream channel to the downstream channel through the pressure chamber.

### BACKGROUND

### Field

The present disclosure relates to an ink jet recording method.

### Description of the Related Art

In recent years, ink jet recording methods have been increasingly used in a field called sign and display, such as printing of posters and large-format advertisements. The recording area in this field is characteristically larger than the recording area of home ink jet recording apparatuses. Furthermore, since images need to attract attention, inks that can record images with high color developability are required.

In the sign and display field, non-absorptive record media formed of vinyl chloride (PVC), poly(ethylene terephthalate) (PET), or the like having a surface with almost no ink absorbency are often used. Thus, it is required to suppress blurring and nonuniformity of images on non-absorptive record media. Record media having a surface with almost no ink absorbency are hereinafter also referred to as “non-absorptive record media”. In an ink jet recording method for recording on a non-absorptive record medium, it is important to prevent an ink dot from being repelled on the record medium to suppress blurring. For this purpose, it is necessary to rapidly thicken and fix the ink applied to the record medium.

A recording method using a solvent-based ink composed mainly of an organic solvent or a curable ink containing a polymerizable monomer is known as a method for recording on a non-absorptive record medium. In recent years, however, from the perspective of environmental load and safety, there is an increasing need for a recording method for recording on a non-absorptive record medium using an aqueous ink.

A method for recording on a non-absorptive record medium using an aqueous ink may be a method of evaporating water in the ink on the surface of the non-absorptive record medium or a method of using a reaction liquid for aggregating a component of the ink. The former is advantageous from the perspective of running cost because it is not necessary to provide a unit for applying a reaction liquid, but is inferior in productivity because it is necessary to reduce the recording speed. Thus, a method of using a reaction liquid has been studied.

Furthermore, to improve productivity, it is necessary to shorten the time required for maintenance of a liquid ejection head and to enable continuous recording. The maintenance of a liquid ejection head is necessary to suppress a decrease in ejection properties due to thickening of a reaction liquid or an ink or solidification of a component, such as a pigment or a resin, in the reaction liquid or the ink in an ejection port not mainly used during continuous recording. Thus, there is a need for an ink jet recording method using a reaction liquid that maintains stable ejection without interruption of recording even in continuous recording for a long period.

A liquid ejection head has been proposed that has a mechanism to induce ink flow near an ejection port of the liquid ejection head to suppress stagnation of an ink component, such as a pigment or a resin, in an ink channel of the liquid ejection head (see Japanese Patent Laid-Open No. 2007-118611). Furthermore, to improve the cleaning recovery of an ejection port for ejecting a reaction liquid, an ink jet recording method using a liquid ejection head having a circulatory channel has been proposed (see Japanese Patent Laid-Open No. 2020-104487).

### SUMMARY

The present inventors have found that a liquid ejection head only having a circulatory channel can have some intermittent ejection stability in the liquid ejection head using a reaction liquid but causes image unevenness.

Accordingly, the present disclosure provides an ink jet recording method in which a reaction liquid or an ink has high ejection stability.

The present disclosure discloses an ink jet recording method for recording an image on a record medium using a liquid ejection apparatus, the method including: ejecting an aqueous ink from a first ejection port; and ejecting, from a second ejection port, an aqueous reaction liquid containing a reactant that reacts with the aqueous ink, wherein the liquid ejection apparatus includes: an element substrate having the second ejection port configured to eject the aqueous reaction liquid, a pressure chamber configured to supply the aqueous reaction liquid to the second ejection port, and an energy-generating element configured to generate energy to eject the aqueous reaction liquid; an upstream channel configured to supply the aqueous reaction liquid to the pressure chamber; and a downstream channel in communication with the pressure chamber, and the element substrate has a face configured to face the record medium in an ejection direction of the aqueous reaction liquid, wherein the method further including ejecting the aqueous reaction liquid from the second ejection port which is located closer to the pressure chamber than the face in a direction perpendicular to the face, and flowing the aqueous reaction liquid from the upstream channel to the downstream channel through the pressure chamber.

Further features of the present disclosure will become apparent from the following description of exemplary embodiments with reference to the attached drawings.

### BRIEF DESCRIPTION OF THE DRAWINGS

FIG. 1 is a view of a liquid ejection apparatus according to the present disclosure.

FIG. 2 is a conceptual diagram of a control system according to the present disclosure.

FIG. 3 is a schematic view of a circulation path of a liquid according to the present disclosure.

FIGS. 4A and 4B are perspective views of a liquid ejection head according to the present disclosure.

FIG. 5 is an exploded perspective view of a liquid ejection head according to the present disclosure.

FIGS. 6A to 6D are plan views of a channel member according to the present disclosure.

FIGS. 7A and 7B are a perspective view and a cross-sectional view of a channel member and an ejection module according to the present disclosure.

FIGS. 8A and 8B are a perspective view and an exploded perspective view of an ejection module according to the present disclosure.

FIGS. 9A to 9C are plan views of an element substrate according to the present disclosure.

FIG. 10 is a cross-sectional view of an element substrate according to the present disclosure.

FIGS. 11A and 11B are schematic views of a temperature regulator in an element substrate according to the present disclosure.

FIG. 12 is a partial enlarged plan view of an adjacent portion of an element substrate according to the present disclosure.

FIGS. 13A and 13B are a plan view and a cross-sectional view of the inside of a liquid ejection head according to the present disclosure.

FIGS. 14A and 14H are schematic views of a transient step of an ejection phenomenon in the present disclosure.

FIGS. 15A and 15B are enlarged plan views of the vicinity of an ejection port of a liquid ejection head according to the present disclosure.

FIG. 16A is a perspective view of a modification example of an ejection module of a liquid ejection head according to a first embodiment, FIG. 16B is an exploded perspective view thereof, and FIG. 16C is a cross-sectional view thereof.

FIG. 17 is a schematic view of the application state of an adhesive agent in FIGS. 16A to 16C.

FIG. 18 is a perspective view of a modification example of the ejection module of the liquid ejection head according to the first embodiment.

FIG. 19A is a perspective view of a modification example of the ejection module of the liquid ejection head according to the first embodiment, and FIGS. 19B and 19C are partial enlarged views thereof.

FIG. 20A is a schematic view of an ejection module of the liquid ejection head according to the first embodiment, FIG. 20B is a partial enlarged view thereof, and FIG. 20C is a cross-sectional view thereof.

FIG. 21A is a plan view of a plurality of protective members of the liquid ejection head according to the first embodiment formed in a sheet shape, and FIGS. 21B and 21C are partial enlarged views thereof.

FIGS. 22A to 22C are a cross-sectional view of an element substrate according to the first embodiment and cross-sectional views of a modification example thereof.

FIGS. 23A to 23E are enlarged views of a depressed portion and an opening portion of a protective member of the liquid ejection head according to the first embodiment.

FIG. 24 is an enlarged view of the protective member and ejection ports of the liquid ejection head according to the first embodiment.

FIGS. 25A to 25D are cross-sectional views of the vicinity of an ejection port of a liquid ejection head according to a second embodiment.

### DESCRIPTION OF THE EMBODIMENTS

The present disclosure is described in detail in the following embodiments. In the following description, an aqueous ink and a reaction liquid for ink jet may be referred to simply as an “ink” and a “reaction liquid”, respectively.

### <Ink Jet Recording Method>

In an ink jet recording method according to the present disclosure, an aqueous ink and an aqueous reaction liquid described later is ejected from an ink jet liquid ejection head to record an image on a record medium. The method can include a reaction liquid ejection step of ejecting an aqueous reaction liquid containing a reactant that reacts with the aqueous ink from an ejection port onto a record medium and an ink application step of applying the aqueous ink so as to overlap at least part of a region to which the aqueous reaction liquid is applied. Furthermore, the reaction liquid ejection step can be provided before the ink application step, or the ink application step and the reaction liquid ejection step can be performed in parallel. In the present disclosure, it is not necessary to provide a step of curing an image by irradiation with an active energy ray or the like.

The record medium may be, but is not limited to, a transparent or colored record medium. The record medium may be a less absorbent medium (non-absorptive medium) with low liquid medium absorbency, such as a resin film. In the case of a so-called serial liquid ejection head and an ink jet recording method in which recording is performed while scanning a record medium, application of ink to a unit region of the record medium can be multipass recording performed by multiple times of relative scanning between the liquid ejection head and the record medium. In particular, when a white ink is used as described later, the application of the white ink and the application of a chromatic color ink or an aqueous reaction liquid to a unit region can be performed by different relative scans. In particular, the white ink and the chromatic color ink can be applied to the unit region by different relative scans. This increases the time intervals between inks coming into contact with each other and easily suppresses mixing of the inks. The unit region can be set as an arbitrary region, such as one pixel or one band.

### (1) Liquid Ejection Apparatus

Appropriate embodiments of a liquid ejection apparatus (ink jet recording apparatus) that can be used in an ink jet recording method according to the present disclosure are described in detail below with reference to the accompanying drawings. However, the following description does not limit the scope of the present disclosure. For example, the present embodiment employs a thermal system of generating a bubble by a heating element to eject liquid. The present disclosure can also be applied to a liquid ejection head utilizing a piezoelectric system of using a piezoelectric element as an energy-generating element to eject liquid or utilizing another liquid ejection system. A liquid ejection head according to the present disclosure that ejects liquid, such as ink, and a liquid ejection apparatus equipped with the liquid ejection head can be applied to a printer, a copying machine, a facsimile including a communication system, or a word processor including a printer unit. They can also be applied to an industrial recording apparatus combined with various processing apparatuses. For example, they can also be used in applications, such as biochip production, electronic circuit printing, and semiconductor substrate production.

The present embodiment is an ink jet recording apparatus (recording apparatus) in which liquid, such as ink, is circulated between a tank and a liquid ejection head, but another form is also possible. For example, instead of circulating the ink, two tanks may be provided on the upstream side and the downstream side of the liquid ejection head, and the ink may flow from one tank to the other tank to induce ink flow in the pressure chamber. Although the present embodiment is a so-called line (page wide) head with a length corresponding to the width of a record medium, the present disclosure can also be applied to a so-called serial liquid ejection head that performs recording while scanning a record medium. The serial liquid ejection head is, for example, but not limited to, a head with one element substrate for a black ink and one element substrate for a chromatic color ink. It also may be a short line head that has several element substrates arranged so that ejection ports overlap in the ejection port array direction and is shorter than the width of a record medium, and the record medium may be scanned with the short line head.

Examples of embodiments of the present disclosure are described below with reference to the drawings.

### <Basic Configuration of Present Disclosure>

### Overall Configuration of Liquid Ejection Apparatus

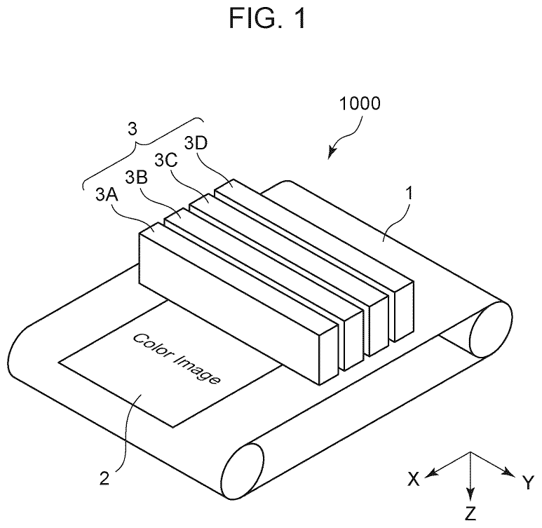

FIG. 1 is a view of an example of a liquid ejection apparatus according to the present embodiment. The liquid ejection apparatus according to the present embodiment is a liquid ejection apparatus 1000 (hereinafter also referred to simply as an apparatus 1000) as an ink jet recording apparatus that records an image on a record medium 2 by ejecting an aqueous ink and an aqueous reaction liquid that reacts with the aqueous ink. In the drawing, the X direction is the conveying direction of the record medium 2, the Y direction is the width direction of the record medium 2, and the Z direction is a direction intersecting the X direction and the Y direction and is a direction in which liquid is ejected.

FIG. 1 illustrates the apparatus 1000 in which a liquid ejection head 3 directly applies liquids (an ink and a reaction liquid) to the record medium 2 conveyed in the X direction. The record medium 2 is mounted on a conveying unit 1 and is conveyed in the X direction at a predetermined speed below four liquid ejection heads 3 (3A, 3B, 3C, and 3D) that eject different liquids. In FIG. 1, the four liquid ejection heads 3 are arranged in the order of 3D, 3C, 3B, and 3A in the X direction, and liquids corresponding to the respective liquid ejection heads 3 are applied to the record medium 2 in this order. Each liquid ejection head 3 has a plurality of ejection ports configured to eject liquid arranged in the Y direction. The ejection ports are provided in an element substrate described later, and a plane of the element substrate facing the record medium 2 in the liquid ejection direction is referred to as an orifice face.

As described above, the ink application step can follow the reaction liquid ejection step, and the apparatus 1000 in FIG. 1 can be configured so that the liquid ejection head 3D ejects the reaction liquid and the liquid ejection heads 3A, 3B, and 3C eject the ink.

The record medium 2 is a cut paper in FIG. 1 but may be a continuous form supplied from rolled paper. The record medium is not limited to paper and may be a film or the like.

The present embodiment describes an ink jet recording apparatus in which one liquid ejection head ejects one type of liquid, a liquid ejection head (first liquid ejection head) ejects the ink, and a liquid ejection head (second liquid ejection head) ejects the reaction liquid. However, one liquid ejection head may be configured to eject a plurality of types of liquids, and the present disclosure can be suitably used even in a configuration in which one liquid ejection head is configured to eject the aqueous ink and the aqueous reaction liquid.

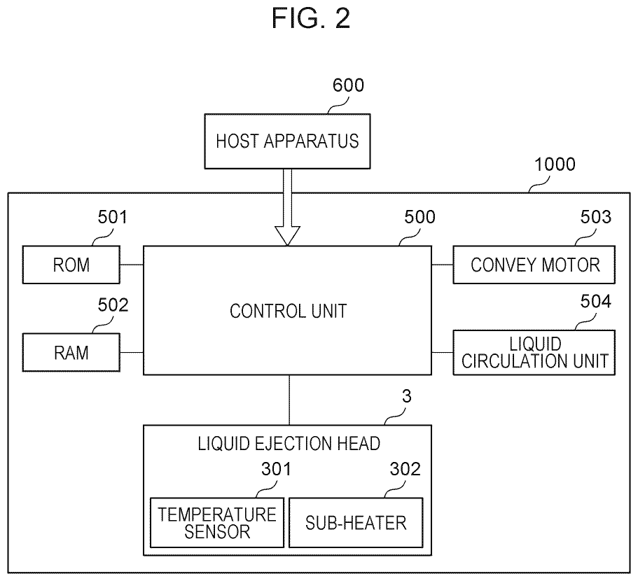

FIG. 2 is a block diagram for explaining a control configuration in the apparatus 1000. A control unit 500 is composed of CPU and the like and controls the entire apparatus 1000 while using a RAM 502 as a work area in accordance with a program and various parameters stored in a ROM 501. The control unit 500 performs predetermined image processing on image data received from a host apparatus 600 connected to the outside in accordance with a program and parameters stored in the ROM 501 and generates ejection data that can be ejected by the liquid ejection head 3. The liquid ejection head 3 is driven in accordance with the ejection data to eject ink at a predetermined frequency. The apparatus 1000 further has a liquid circulation unit 504, which circulates and supplies an ink to the liquid discharge head 3. The liquid circulation unit 504 controls an entire ink circulation system including a pressure control unit and a switching mechanism, under the control of the control unit 500.

During the ejection operation by the liquid ejection head 3, the control unit 500 drives a convey motor 503 to convey the record medium 2 in the X direction at a speed corresponding to the drive frequency. Consequently, an image corresponding to the image data received from the host apparatus 600 is recorded on the record medium 2. In the ROM 501, information on the use region of an ejection port used for ejection in the liquid ejection head 3 is stored in a rewritable manner for each liquid ejection head 3. A method of setting the use region is described in detail later.

### Liquid Circulation Path

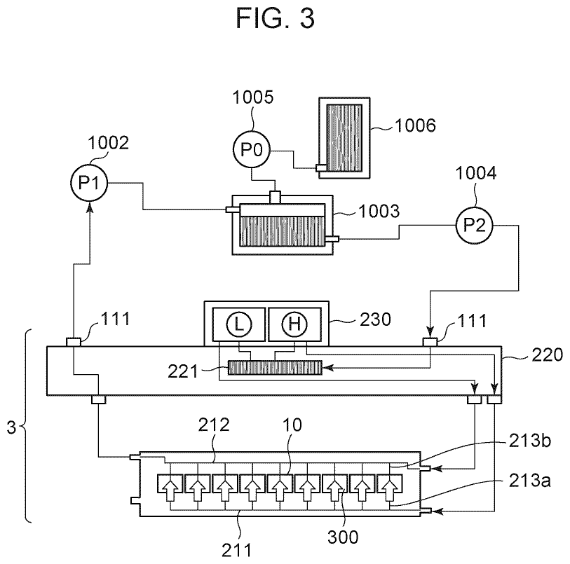

FIG. 3 is a schematic view illustrating a liquid circulation path in the apparatus 1000 of the present embodiment, in which the liquid ejection head 3 is fluidly connected to a first circulation pump 1002, a buffer tank 1003, and the like. Although FIG. 3 illustrates only a path through which a liquid of one color of a liquid ejection head corresponding to the liquid flows, the main body of the apparatus 1000 has a circulation path corresponding to the type of liquid to be ejected.

The buffer tank 1003 as a sub tank connected to a main tank 1006 has an air communication port (not shown) for communication between the inside and outside of the tank and can discharge bubbles from liquid to the outside. The buffer tank 1003 is also connected to a replenishing pump 1005. When liquid is consumed in the liquid ejection head 3 by ejecting (discharging) the liquid from an ejection port of the liquid ejection head, such as ejecting the liquid for recording or suction recovery, the replenishing pump 1005 transfers the consumed liquid from the main tank 1006 to the buffer tank 1003.

The first circulation pump 1002 has a role of drawing liquid from a liquid connection portion 111 of the liquid ejection head 3 and causing the liquid to flow to the buffer tank 1003. When the liquid ejection head 3 is driven, a certain amount of liquid flows in a common collecting channel 212 by the first circulation pump 1002.

A negative pressure control unit 230 is provided in a path between a second circulation pump 1004 and a liquid ejection unit 300. The negative pressure control unit 230 has a function of operating so as to maintain the pressure on the downstream side (the liquid ejection unit 300 side) of the negative pressure control unit 230 at a preset constant pressure even when the flow rate of the circulation system fluctuates due to a difference in duty at which recording is performed.

As illustrated in FIG. 3, the negative pressure control unit 230 includes two pressure regulating mechanisms, and different control pressures are set in the pressure regulating mechanisms. Of the two pressure regulating mechanisms, one on a relatively high-pressure side (a negative pressure control unit 230H, denoted by H in FIG. 3) and the other on a relatively low-pressure side (a negative pressure control unit 230L, denoted by L in FIG. 3) are connected to a common supply channel 211 and the common collecting channel 212, respectively, in the liquid ejection unit 300 via a liquid supply unit 220. The liquid ejection unit 300 includes the common supply channel 211, the common collecting channel 212, and an individual supply channel 213a and an individual collecting channel 213b in communication with their corresponding element substrates having an ejection port. Details of an element substrate 10 are described later. The individual channels 213a and 213b communicate with the common supply channel 211 and the common collecting channel 212, and part of the liquid flowing from the second circulation pump 1004 flows from the common supply channel 211 through an inner channel of the element substrate 10 to the common collecting channel 212 (arrows in FIG. 3). This is because a pressure difference is provided between the pressure regulating mechanism H connected to the common supply channel 211 and the pressure regulating mechanism L connected to the common collecting channel 212, and the first circulation pump 1002 is connected only to the common collecting channel 212.

Thus, in the liquid ejection unit 300, there are a liquid flow through the common collecting channel 212 and a flow from the common supply channel 211 through each element substrate 10 to the common collecting channel 212. This can dissipate the heat generated in each element substrate 10 to the outside of the element substrate 10 by the flow from the common supply channel 211 to the common collecting channel 212. During recording with the liquid ejection head 3, such a configuration can generate a liquid flow even in an ejection port or a pressure chamber not involved in recording and can suppress the thickening of the liquid in these portions. Furthermore, thickened liquid or a foreign substance in the liquid can be discharged to the common collecting channel 212. Thus, the liquid ejection head 3 of the present embodiment can perform high-speed and high-quality recording.

### Configuration of Liquid Ejection Head

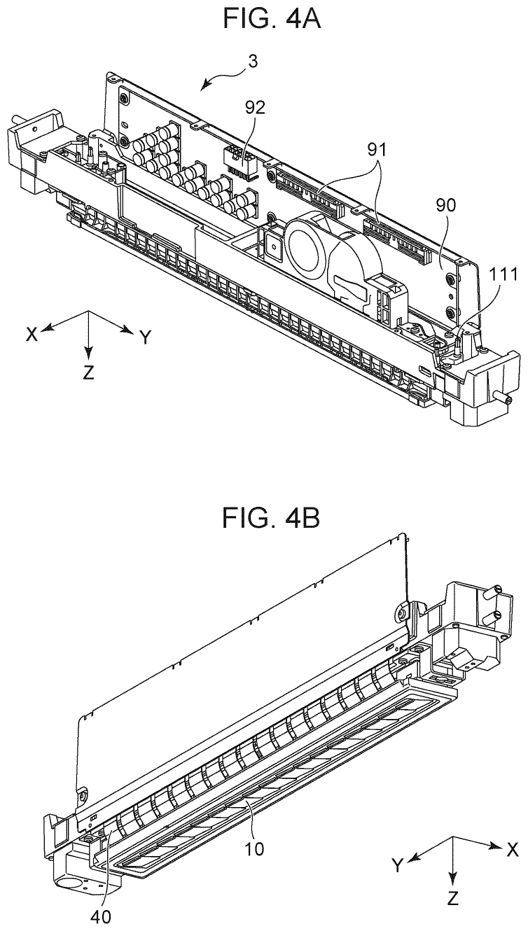

FIGS. 4A and 4B are perspective views of the liquid ejection head 3 according to the present embodiment. The liquid ejection head 3 is a line liquid ejection head including 17 element substrates 10 capable of ejecting liquid arranged in a straight line (in-line arrangement). As illustrated in FIGS. 4A and 4B, the liquid ejection head 3 includes the element substrates 10, a flexible printed circuit board 40, and a signal input terminal 91 and a power supply terminal 92 electrically connected via an electric wiring board 90. The signal input terminal 91 and the power supply terminal 92 are electrically connected to the control unit of the apparatus 1000 and supply an ejection drive signal and electric power necessary for ejection to the element substrates 10, respectively. Wiring can be concentrated by an electric circuit in the electric wiring board 90 to make the number of the signal input terminals 91 and the power supply terminals 92 smaller than the number of the element substrates 10. This can reduce the number of electrical connection portions to be removed when the liquid ejection head 3 is mounted in the apparatus 1000 or when the liquid ejection head 3 is replaced. As illustrated in FIG. 4A, the liquid connection portion 111 provided on one side of the liquid ejection head 3 is connected to a liquid supply system of the apparatus 1000. Thus, the liquid is supplied from the supply system of the apparatus 1000 to the liquid ejection head 3, and the liquid passing through the liquid ejection head 3 is recovered to the supply system of the apparatus 1000. In this way, the liquid can be circulated through the path of the apparatus 1000 and the path of the liquid ejection head 3.

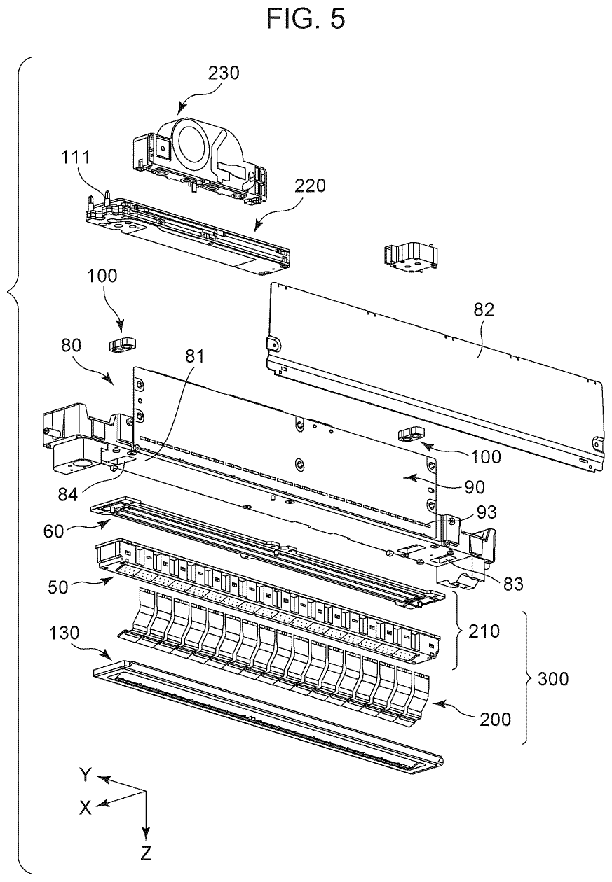

FIG. 5 is an exploded perspective view of each component or unit constituting the liquid ejection head 3. The liquid ejection unit 300, the liquid supply unit 220, and the electric wiring board 90 are attached to a housing 80. The liquid supply unit 220 is provided with the liquid connection portion 111, and a filter 221 (FIG. 3) in communication with each opening of the liquid connection portion 111 is provided inside the liquid supply unit 220 to remove a foreign substance from the liquid supplied. The liquid passing through the filter 221 is supplied to the negative pressure control unit 230 on the liquid supply unit 220. The negative pressure control unit 230 is composed of a pressure-regulating valve and, due to the action of a valve, a spring member, or the like provided therein, significantly attenuates a change in pressure drop in the supply system of the apparatus 1000 (the supply system on the upstream side of the liquid ejection head 3) caused by a change in the flow rate of the liquid. This can stabilize the negative pressure change on the downstream side (the liquid ejection unit 300 side) of the negative pressure control unit 230 within a certain range. Two pressure-regulating valves are incorporated in the negative pressure control unit 230 and are set to different control pressures. The high-pressure side communicates with the common supply channel 211 in the liquid ejection unit 300, and the low-pressure side communicates with the common collecting channel 212 via the liquid supply unit 220.

The housing 80 is composed of a liquid ejection unit support portion 81 and an electric wiring board support portion 82, supports the liquid ejection unit 300 and the electric wiring board 90, and secures the rigidity of the liquid ejection head 3. The electric wiring board support portion 82 supports the electric wiring board 90 and is fastened with screws to the liquid ejection unit support portion 81. The liquid ejection unit support portion 81 has openings 83 and 84 into which a joint rubber 100 is inserted. The liquid supplied from the liquid supply unit 220 is guided to a second channel member 60 constituting the liquid ejection unit 300 via the joint rubber 100.

Next, the configuration of a channel member 210 in the liquid ejection unit 300 is described. As illustrated in FIG. 5, the channel member 210 is composed of a first channel member 50 and the second channel member 60 stacked. The channel member 210 distributes the liquid supplied from the liquid supply unit 220 to each ejection module 200 and returns the liquid circulated from the ejection module 200 to the liquid supply unit 220. A plurality of ejection modules 200 are bonded with an adhesive agent (not shown) to a bonding surface of the first channel member 50. The channel member 210 is fastened with screws to the liquid ejection unit support portion 81, which suppresses warping or deformation of the channel member 210.

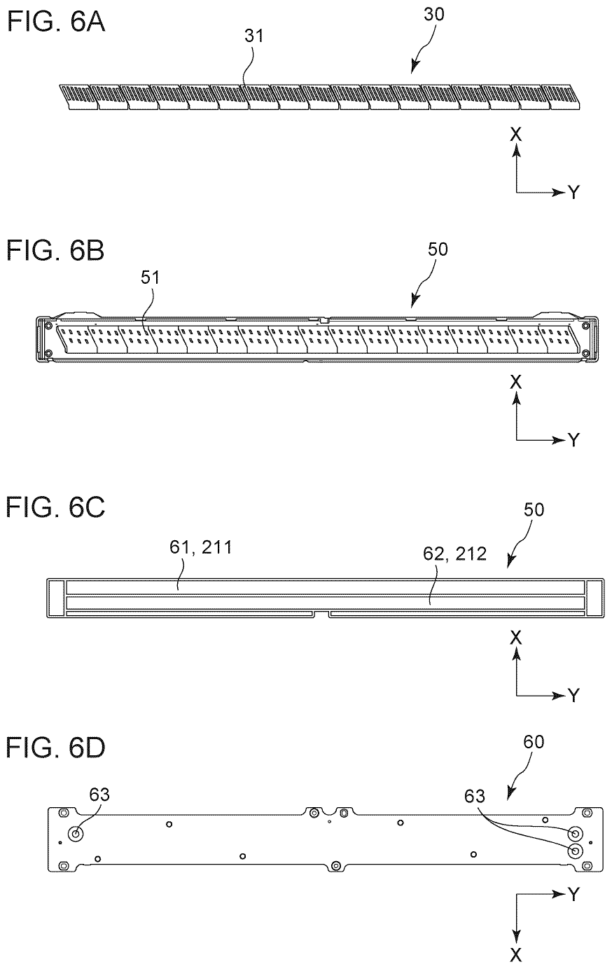

FIGS. 6A to 6D are explanatory views of the detailed configuration of the channel member 210. FIG. 6A illustrates a support member 30 on a surface of the first channel member 50 on which the ejection module 200 is to be mounted, and FIG. 6B illustrates a surface of the first channel member 50 to come into contact with the support member 30. FIG. 6C is a cross-sectional view of a surface of the first channel member 50 perpendicular to the Z direction and near the center in the Z direction, and FIG. 6D illustrates a surface of the second channel member 60 to come into contact with the liquid ejection unit support portion 81. FIGS. 6A to 6C are viewed from the ejection module 200 side, and FIG. 6D is viewed from the liquid ejection unit support portion 81 side.

A plurality of support members 30 arranged in the Y direction are disposed on a surface of the first channel member 50 opposite the second channel member 60, and one element substrate 10 is disposed on each support member 30. The number of arrays of the ejection modules 200 can be adjusted to configure liquid ejection heads 3 of various sizes.

As illustrated in FIG. 6A, the support member 30 has a communication port 31, which is fluidly connected to the element substrate 10 and serves as the individual supply channel 213a and the individual collecting channel 213b described above with reference to FIG. 3, on a surface that comes into contact with the element substrate 10. As illustrated in FIG. 6B, the communication port 31 is in fluid communication with the common supply channel 211 or the common collecting channel 212 via a communication port 51 of the channel member 50.

As illustrated in FIG. 6C, in a middle layer near the center of the first channel member 50 in the Z direction, common channels 61 and 62, which serve as the common supply channel 211 and the common collecting channel 212 described with reference to FIGS. 3A and 3B, extend in the Y direction. As illustrated in FIG. 6D, a common communication port 63 in fluid communication with the liquid supply unit 220 is formed at both ends or one end of the common channels 61 and 62.

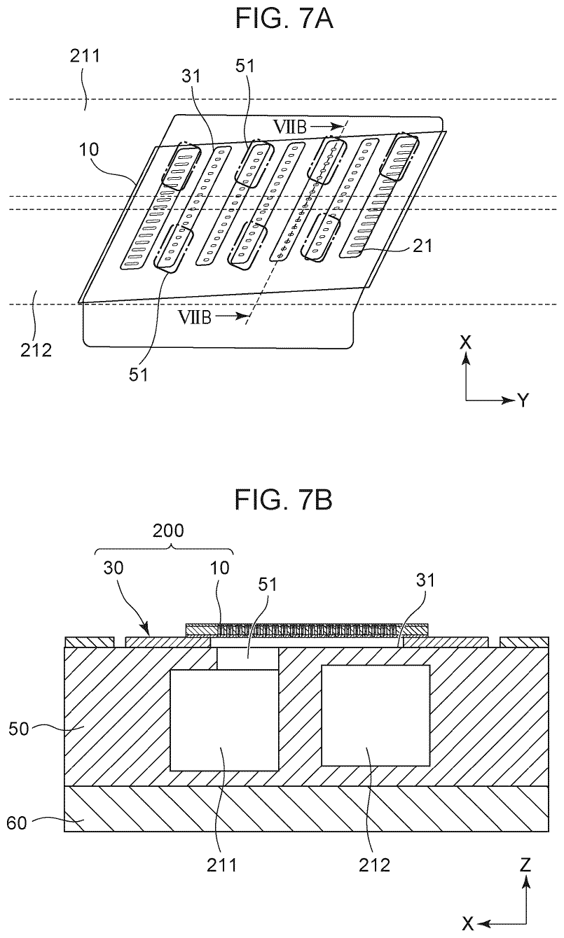

FIGS. 7A and 7B are a perspective view and a cross-sectional view for explaining a channel structure formed inside the liquid ejection unit 300. FIG. 7A is an enlarged perspective view of the channel member 210 viewed from the Z direction, and FIG. 7B is a cross-sectional view taken along the line VIIB-VIIB of FIG. 7A.

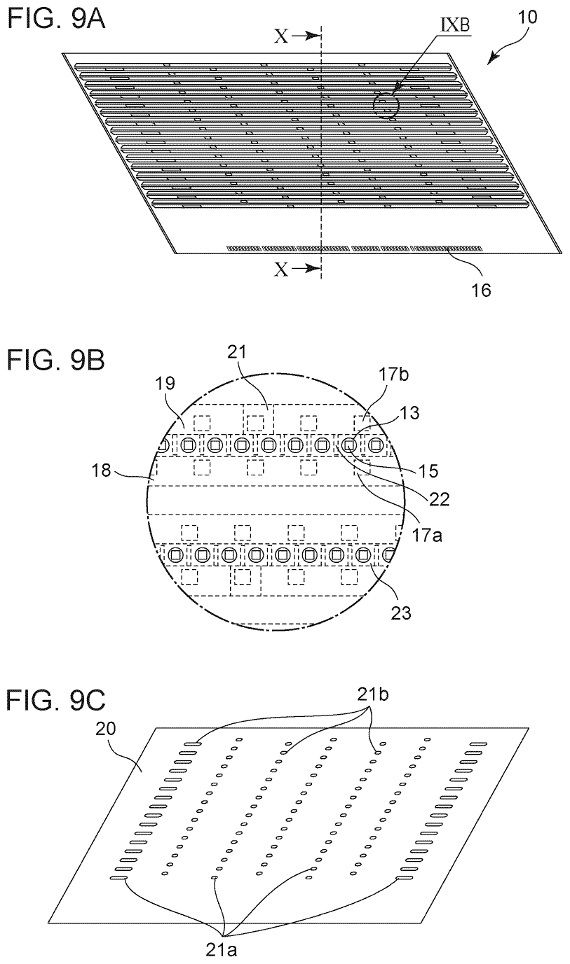

The element substrate 10 of the ejection module 200 is mounted on the communication port 51 of the first channel member 50 via the support member 30. Although only the communication port 51 corresponding to the common supply channel 211 is illustrated in FIG. 7B, the common collecting channel 212 communicates with the communication port 51 in another cross section, as illustrated in FIGS. 6A to 6D. A channel for supplying the liquid from the first channel member 50 to a recording element 15 (see FIGS. 9A to 9C) on the element substrate 10 is formed in the support member 30 and the element substrate 10 included in each ejection module 200. Furthermore, in the support member 30 and the element substrate 10, a channel for recovering (circulating) part or all of the liquid supplied to the recording element 15 to the first channel member 50 is formed.

As described above, the common supply channel 211 is connected to the negative pressure control unit 230H with a relatively high pressure, and the common collecting channel 212 is connected to the negative pressure control unit 230L with a relatively low pressure. A supply path for supplying the liquid to a channel formed in the element substrate 10 through the common communication port 63 (see FIGS. 6A to 6D), the common supply channel 211, and the communication port 31 is formed. Similarly, a collection path is formed, which passes the communication port 31, the communication port 51, the common collecting channel 212, and the common communication port 63 (see FIG. 6D) from the channel in the element substrate 10. While the liquid is circulated in this manner, an ejection operation in accordance with ejection data is performed in the element substrate 10, and the liquid supplied through the supply path and not consumed by the ejection operation is collected through the collection path.

### Configuration of Ejection Module

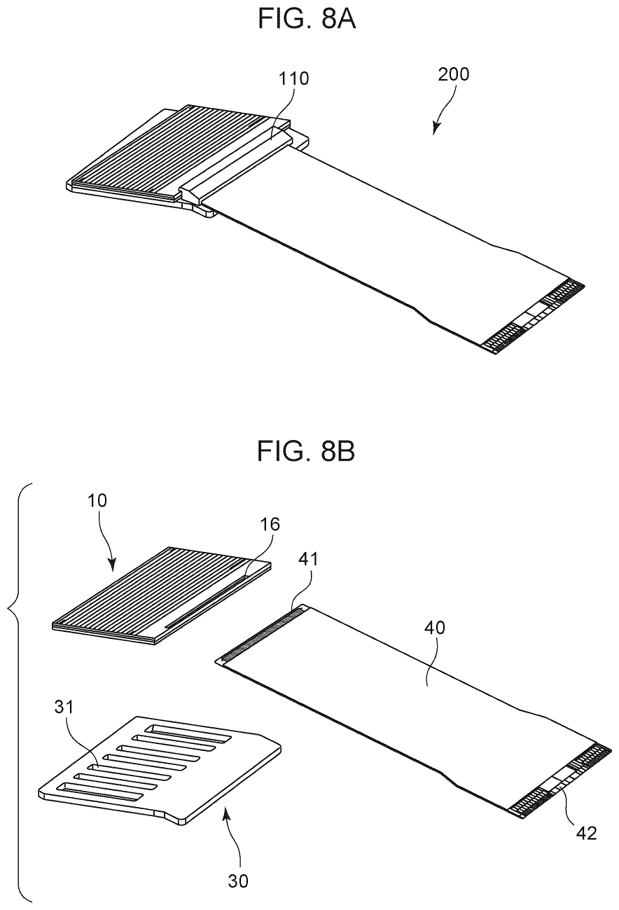

FIG. 8A is a perspective view of one ejection module 200, and FIG. 8B is an exploded view thereof. In a method for producing the ejection module 200, first, the element substrate 10 and the flexible printed circuit board 40 are bonded onto the support member 30 in which the communication port 31 is provided in advance. A terminal 16 on the element substrate 10 and a terminal 41 on the flexible printed circuit board 40 are then electrically connected to each other by wire bonding, and the wire bonding portion (electrical connection portion) is then covered and sealed with a sealant (sealing portion 110). A terminal 42 of the flexible printed circuit board 40 opposite the element substrate 10 is electrically connected to a connection terminal 93 (see FIG. 5) of the electric wiring board 90. The support member 30, which is a supporting body for supporting the element substrate 10 and is a channel member for fluid communication between the element substrate 10 and the channel member 210, can have high flatness and can be bonded to the element substrate with sufficiently high reliability. The material can be, for example, alumina or a resin material.

### Configuration of Element Substrate

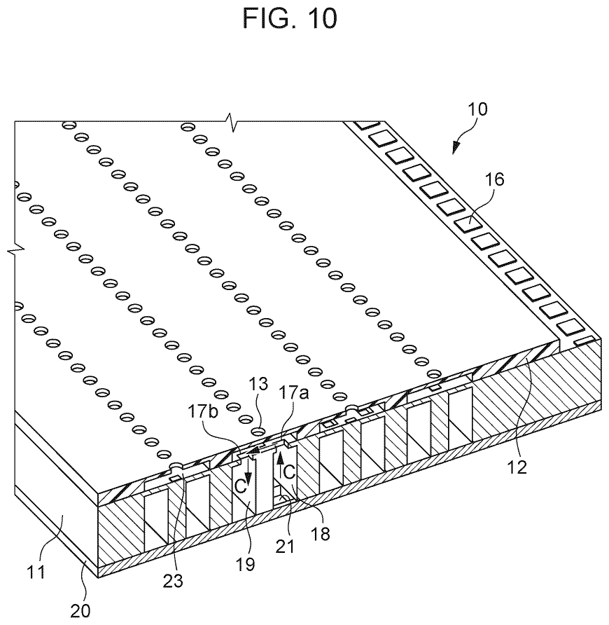

The configuration of the element substrate 10 according to the embodiment is described below. FIG. 9A is a plan view of a plane of the element substrate 10 on which the ejection port 13 is formed, FIG. 9B is an enlarged view of a portion indicated by IXB in FIG. 9A, and FIG. 9C is a plan view of the back surface of FIG. 9A. FIG. 10 is a cross-sectional perspective view of the element substrate 10 taken along the line X-X of FIG. 9A. A direction in which an ejection port array of a plurality of ejection ports 13 extends is hereinafter referred to as an “ejection port array direction”.

As illustrated in FIG. 9B, a heating resistance element 15, which is a heating element (pressure-generating element) for bubbling the liquid using thermal energy generated, is arranged at a position corresponding to each ejection port 13. A pressure chamber 23 including the heating resistance element 15 therein is partitioned by a partition 22 formed of a first layer 121 (described later) of a channel-forming member 12. The heating resistance element 15 is electrically connected to the terminal 16 by electric wiring (not shown) provided on the element substrate 10. The heating resistance element 15 generates heat and boils the liquid based on a pulse signal input from a control circuit of the liquid ejection apparatus 1000 via the electric wiring board 90 (see FIG. 5) and the flexible printed circuit board 40 (see FIGS. 8A and 8B). The liquid is ejected from the ejection port 13 by the force of bubbling due to the boiling. As illustrated in FIG. 9B, along each ejection port array, a liquid supply channel 18 extends on one side, and a liquid collecting channel 19 extends on the other side. The liquid supply channel 18 and the liquid collecting channel 19 are channels extending in the ejection port array direction provided in the element substrate 10 and communicate with the ejection port 13 via a supply port 17a and a collection port 17b, respectively. FIGS. 9A to 9C illustrate the element substrate 10 having 16 ejection port arrays as an example.

As illustrated in FIGS. 9C and 10, a sheet-like cover plate 20 is disposed on the back surface of the element substrate 10 opposite the plane on which the ejection ports 13 are formed. As illustrated in FIG. 9C, the cover plate 20 has a plurality of openings 21 that communicate with the liquid supply channel 18 and the liquid collecting channel 19 described later. In the present embodiment, the cover plate 20 has four supply openings 21a for one liquid supply channel 18 and three collection openings 21b for one liquid collecting channel 19, but the number of openings is not limited to these. As illustrated in FIG. 9B, each opening 21 in the cover plate 20 communicates with the communication port 51 illustrated in FIG. 7A. The cover plate 20 can be made of a material that has sufficient corrosion resistance to the liquid, and the shape and position of the openings 21 are required to be highly accurate so that the liquid is supplied to the pressure chamber. Thus, a photosensitive resin material or a silicon plate can be used as a material of the cover plate 20 to provide the openings 21 by photolithography. Thus, the cover plate 20 changes the pitch of the channels by the openings 21, and it is desirable that the cover plate be formed of a film-like member with a thickness in the range of approximately 30 to 600 μm from the perspective of pressure loss, strength, and processability.

Next, the liquid flow in the element substrate 10 is described. In the element substrate 10, a substrate 11 formed of silicon and a channel-forming member (ejection-port-forming member) 12 formed of a photosensitive resin are stacked. In the present embodiment, the channel-forming member 12 includes the first layer 121 (middle layer) for forming the pressure chamber 23 and a second layer 122 (upper layer) having the ejection ports 13. The channel-forming member 12 is formed by stacking (laminating) the first layer 121 and the second layer 122 in this order on a plane (first plane 11a) of the substrate 11, patterning them by exposure to light with their respective optimal photosensitive wavelengths, and then developing them. The channel-forming member 12 can be produced by the method of stacking the first layer and the second layer or by any other method, such as a method of forming a pressure chamber and an ejection port using a mold material or the like. The cover plate 20 is bonded to the back surface of the substrate 11. The cover plate 20 functions as a cover that forms a portion of the walls of the liquid supply channel 18 and the liquid collecting channel 19 formed in the substrate 11 of the element substrate 10. In the element substrate 10, the heating resistance element 15 is formed on one plane side of the substrate 11 (see FIGS. 9A to 9C), and grooves constituting the liquid supply channel 18 and the liquid collecting channel 19 extending along the ejection port array are formed on the back surface thereof. The liquid supply channel 18 and the liquid collecting channel 19 formed by the substrate 11 and the cover plate 20 are respectively connected to the common supply channel 211 and the common collecting channel 212 in the channel member 210 (see FIGS. 7A and 7B), and a differential pressure is generated between the liquid supply channel 18 and the liquid collecting channel 19. This differential pressure forms a circulatory flow C of the liquid in the liquid supply channel 18 provided in the substrate 11 flowing to the liquid collecting channel 19 via the supply port 17a, the pressure chamber 23, and the collection port 17b (a flow indicated by arrows C in FIG. 10). In the ejection ports 13 and the pressure chamber 23 in which the ejection operation is not performed, this flow can collect thicker ink, bubbles, foreign substances, and the like generated by evaporation from the ejection port 13 to the liquid collecting channel 19. This can also suppress the thickening of the ink in the ejection port 13 or in the pressure chamber 23 or an increase in the density of a coloring material. As illustrated in FIGS. 7A and 7B, the liquid collected in the liquid collecting channel 19 is collected in the order of the communication port 31 of the support member 30, the communication port 51 of the first channel member 50, and the common collecting channel 212 through the openings 21 of the cover plate 20 and the communication port 31 of the support member 30 and is collected in the supply path of the liquid ejection apparatus 1000.

In other words, the liquid supplied from the liquid ejection apparatus main body to the liquid ejection head 3 flows in the following order and is supplied and collected. The liquid first flows from the liquid connection portion 111 of the liquid supply unit 220 into the liquid ejection head 3. The liquid is then supplied to the joint rubber 100, the common communication port 63 in the second channel member, the common channel 61 in the first channel member, and the communication port 51 in this order. The liquid is then supplied to the pressure chamber 23 via the communication port 31 in the support member 30, the openings 21 in the cover plate 20, and the liquid supply channel 18 and the supply port 17a in the substrate 11 in this order. The liquid supplied to the pressure chamber 23 and not ejected from the ejection port 13 flows through the collection port 17b and the liquid collecting channel 19 in the substrate 11, the openings 21 in the cover plate 20, and the communication port 31 in the support member 30 in this order. The liquid then flows through the communication port 51 and the common channel 62 in the first channel member, the common communication port 63 in the second channel member, and the joint rubber 100. The liquid then flows from the liquid connection portion 111 provided in the liquid supply unit to the outside of the liquid ejection head 3. In the form of the circulation path illustrated in FIG. 3, the liquid flowing from the liquid connection portion 111 is supplied to the joint rubber 100 through the negative pressure control unit 230.

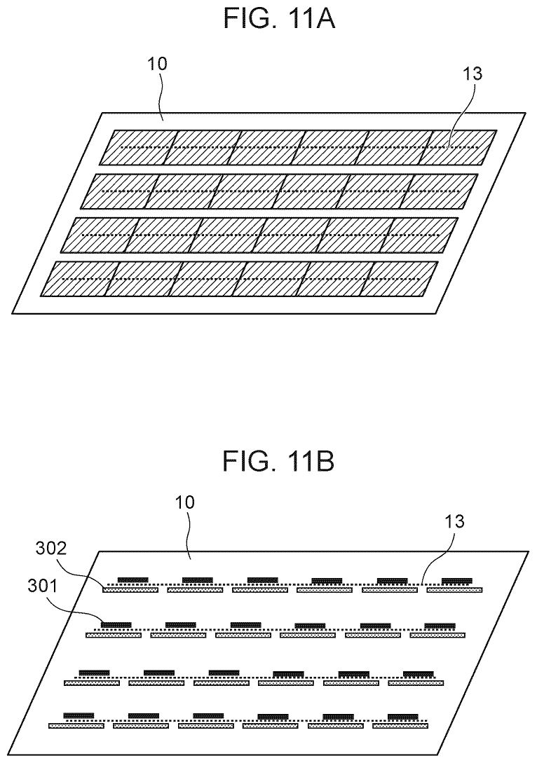

The liquid ejection head of the present embodiment further includes a temperature control mechanism in the element substrate 10. FIGS. 11A and 11B are schematic views of the element substrate 10 partitioned into a plurality of areas for temperature adjustment. A temperature sensor 301 and a sub-heater 302 that can be individually controlled are provided for each area, and the control unit 500 (see FIG. 2) adjusts the temperature based on the temperature (target temperature) set for each area using the temperature sensor 301 and the sub-heater 302. Thus, the control unit 500 drives the sub-heater 302 only in an area where the temperature detected by the temperature sensor 301 is equal to or lower than the target temperature. The target temperature of the element substrate 10 can be set to a relatively high temperature to reduce the viscosity of the liquid and suitably perform the ejection operation or the circulation. Such temperature control is performed to suppress the temperature variation in the element substrate 10 or the temperature variation between a plurality of element substrates 10 within a predetermined range. This can reduce the variation in the ejection volume caused by the temperature variation and suppress the density unevenness in a recorded image. The target temperature of the element substrate 10 can be set to a temperature equal to or higher than the equilibrium temperature of the element substrate 10 when all the heating resistance elements 15 are driven at the assumed highest drive frequency. The temperature sensor 301 may be a diode sensor, an aluminum sensor, or the like. A heating unit of the element substrate 10 may also be a heating resistance element 15, which is a heating element. More specifically, the element substrate 10 may be heated by applying a voltage that does not cause bubbling to the heating resistance element 15. For example, instead of the sub-heater 302, the heating unit may be the heating resistance element 15 or a combination of the sub-heater 302 and the heating resistance element 15.

### Positional Relationship Between Element Substrates

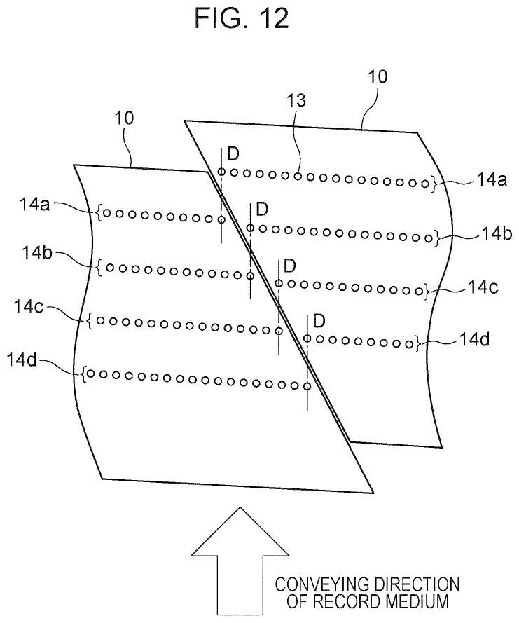

FIG. 12 is a partially enlarged plan view of an adjacent portion of element substrates in two adjacent ejection modules. As illustrated in FIGS. 9A to 9C, in the present embodiment, an element substrate with an approximately parallelogram external shape is used. As illustrated in FIG. 12, each ejection port array (14a to 14d) in which the ejection ports 13 are arranged in each element substrate 10 is inclined at a certain angle with respect to the conveying direction of a record medium. Thus, the ejection port arrays in the adjacent portion of element substrates 10 are arranged such that at least one ejection port overlaps in the conveying direction of a record medium. In FIG. 12, two ejection ports on the line D overlap. With such an arrangement, even if the position of the element substrate 10 is slightly shifted from a predetermined position, a black streak or a white spot on a recorded image can be made inconspicuous by the drive control of overlapping ejection ports. Even when a plurality of element substrates 10 are linearly (in-line) arranged instead of a staggered arrangement, it is possible to take measures against a black streak or a white spot in an overlap portion between the element substrates 10 while suppressing an increase in the length of the liquid ejection head 3 in a record medium conveying direction by the configuration of FIG. 12. Although the element substrate 10 has a parallelogram main face in the present embodiment, the present disclosure is not limited thereto. For example, even when an element substrate with a rectangular shape, a trapezoidal shape, or another shape is used, the configuration of the present disclosure can be applied.

Liquid Flow near Pressure Chamber

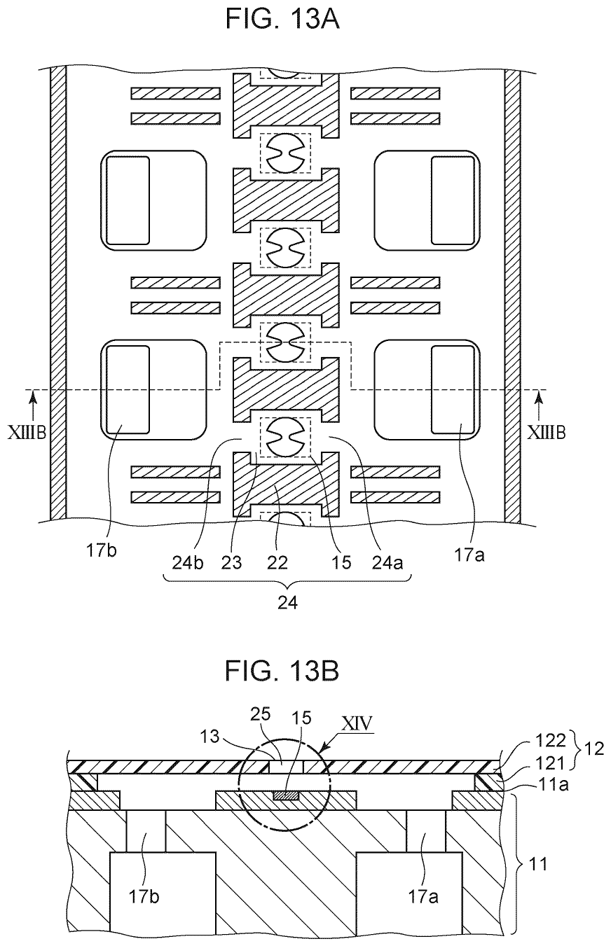

FIGS. 13A and 13B illustrate the inside of a liquid ejection head, FIG. 13A is a plan view (perspective view) of a heating resistance element and a channel, and FIG. 13B is a cross-sectional view taken along the line XIIIB-XIIIB of FIG. 13A. A plurality of pressure chambers 23 each having the ejection port 13, and an inlet channel 24a and an outlet channel 24b that communicate with the respective pressure chambers 23 are provided between the substrate 11 and the channel-forming member 12 of the element substrate 10. The pressure chamber 23 is partitioned by a wall portion (the partition 22) of the channel-forming member 12. The substrate 11 is configured to form the circulatory flow C (see FIG. 10) of the liquid in the liquid supply channel 18 flowing to the liquid collecting channel 19 via the supply port 17a, the inlet channel 24a, the pressure chamber 23, the outlet channel 24b, and the collection port 17b. The rate of the circulatory flow C in the pressure chamber is preferably, for example, 1.0 mm/s or more and 250 mm/s or less and has little influence on the landing accuracy or the like even in an ejection operation performed in a liquid flow state. As illustrated in FIG. 11B, the ejection port 13 is an opening portion positioned at an end portion of a cylindrical ejection port portion 25 formed in the channel-forming member 12, and the ejection port portion 25 communicates between the ejection port 13 and the pressure chamber 23. The direction of the liquid ejected from the ejection port 13 (a vertical direction in FIG. 11B) is referred to as an “ejection direction”, and the liquid flow direction in the pressure chamber 23 (a horizontal direction in FIG. 11B) is referred to simply as a “flow direction”.

A plurality of supply ports 17a form a supply port array, and a plurality of collection ports 17b form a collection port array. An ejection port array of a plurality of ejection ports 13 arranged is formed between the supply port array and the collection port array. In the present embodiment, as described above, a pressure difference is provided between the liquid supply channel 18 and the liquid collecting channel 19. Due to this pressure difference, the liquid is introduced from the supply port 17a into the pressure chamber 23 through the inlet channel 24a, generating the circulatory flow C of the liquid flowing from the outlet channel 24b to the collection port 17b.

The heating resistance element 15 is provided on the bottom face of the pressure chamber 23 facing the ejection port 13. An ejection port portion (nozzle) 25 penetrates the channel-forming member 12 at a position facing the pressure chamber 23. An outer end portion of the ejection port portion 25, that is, an end portion opposite the heating resistance element 15, forms the ejection port 13 through which the liquid is ejected. The ejection port portion 25 or the ejection port 13 is provided at a position facing the heating resistance element 15. In the present specification, the ejection port 13 is an opening in an outer surface of the channel-forming member 12 facing the record medium 2, and the ejection port portion 25 is a portion that communicates between the ejection port 13 and the pressure chamber 23 and means a through-hole that penetrates the channel-forming member 12.

As illustrated in FIGS. 13A and 13B, the present embodiment does not have a filter, such as a columnar structure, often provided on the inlet channel 24a or the outlet channel 24b in the liquid ejection head to prevent a foreign substance, such as dust, from entering the pressure chamber 23. This can reduce the flow resistance, enhance the refilling performance of the liquid, and increase the ejection frequency. In the present embodiment, as described later, a foreign substance can be trapped by a channel (the inlet channel 24a) in the channel-forming member with a relatively low height, and the filter can therefore be eliminated. As a matter of course, a filter may be provided in the inlet channel 24a and the outlet channel 24b on both sides of each pressure chamber 23 or may be provided near the inlet and outlet.

In the liquid ejection head of the present embodiment, the inlet channel 24a, the pressure chamber 23, the ejection port 13, the recording element 15, and the outlet channel 24b constitute an individual channel 24 as one ejection unit, and the liquid supply channel 18 (upstream channel) for supplying the liquid and the liquid collecting channel 19 (downstream channel) for liquid outflow are connected to a plurality of ejection units (individual channels). The upstream channel and the downstream channel separated from each other with the individual channel interposed therebetween can produce an effect of more easily preventing the ejection liquid from being concentrated.

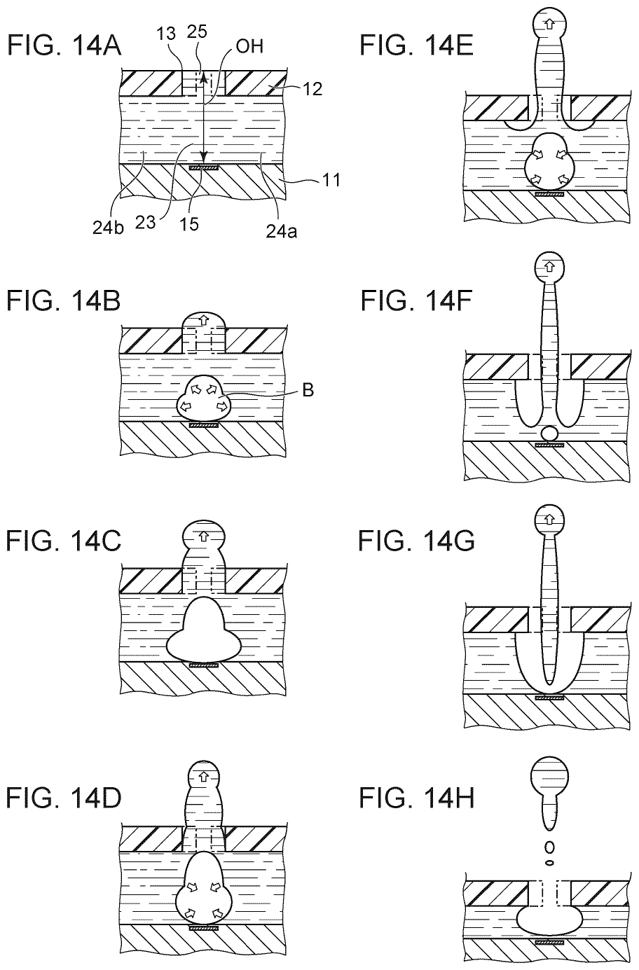

Liquid Ejection Step and Formation of Satellite FIGS. 14A to 14H are schematic views of a transient step of an ejection phenomenon in a portion XIV of FIG. 13B. In FIGS. 14A to 14H, protrusions of the ejection port 13 in FIG. 13A are omitted. The liquid is supplied to the pressure chamber 23 from the inlet channel 24a. When electric energy is applied to the recording element 15, the recording element 15 generates thermal energy used to eject the liquid. The liquid near the recording element 15 is heated and evaporated by the thermal energy, forming a bubble B (FIG. 14B). The pressure at the initial stage of the generation of the bubble B is very high, and the bubble B pushes out the liquid between the bubble B and the ejection port 13 toward the ejection port 13 (see the arrow in FIG. 14C). The bubble B grows and enters the ejection port portion 25. As the bubble B grows, its internal pressure rapidly changes from a positive pressure to a negative pressure lower than the atmospheric pressure (FIG. 14D). The bubble B contracts due to the negative pressure, and the trailing end portion of the droplet is drawn toward the recording element 15, increasing the tail length (see FIGS. 14E and 14F). When the bubble B advances further inside the ejection port portion 25, the bubble B communicates with the atmosphere inside or outside the ejection port portion 25. Consequently, the negative pressure of the bubble B is rapidly lost, and the growth of the tail length is stopped (see FIG. 14G). Through these steps, the liquid between the generated bubble B and the ejection port 13 is ejected from the ejection port 13 by the pressure of the bubble B. The ejected liquid is mainly ejected as a main droplet, but a satellite S or mist is formed behind the main droplet (see FIG. 14H). As the timing of the air communication of the bubble B is delayed, the tail becomes longer, and the droplet is more likely to separate into the main droplet and a satellite due to the speed difference described above and the surface tension of the liquid, which may cause a decrease in recording quality due to the influence of the satellite. Thus, to reduce the decrease in recording quality due to a satellite, it is effective to advance the timing of the air communication and shorten the tail.

It is effective to reduce the resistance against a droplet passing through the ejection port as a method of advancing the timing of the air communication and shortening the tail. Thus, the distance OH from the plane of the pressure chamber 23 having the recording element 15 to the ejection port 13 in the ejection direction is preferably 16 μm or less. Such a dimensional relationship can produce an effect of efficiently applying ejection energy from the recording element to an ejected droplet. This can also further increase the ejection speed of the ejected droplet at the time of the air communication and make the configuration stronger (more robust) against the disturbance of air flow or the like caused by the record medium. On the other hand, an excessively short OH results in excessively high flow resistance, and thus the OH is preferably 13 μm or more.

It is desirable that the inlet channel 24a and the outlet channel 24b have the same flow resistance. A bubble generated by the thermal energy spreads not only in the ejection direction but also in the directions of the inlet channel 24a and the outlet channel 24b (see FIGS. 14B and 14C). At this time, a large difference in flow resistance between the inlet channel 24a and the outlet channel 24b asymmetrically spreads the generated bubble inside the channel. In this case, the tail is also asymmetrically formed, and its axis shifts while the tail contracts and is merging with the main droplet. Thus, the droplet cannot merge successfully and may be more poorly formed.

### Shape of Ejection Port

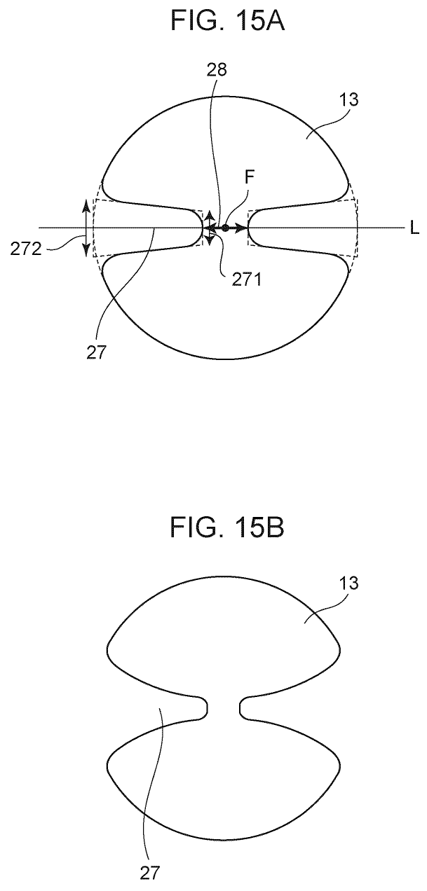

FIG. 15A is a plan view of the shape of an ejection port in the present embodiment. In FIG. 15A, two protrusions 27 are provided on a straight line L passing through the center F of the ejection port 13 so as to protrude toward the center F in the same shape on both sides of the center F. This can produce an effect of shortening the tail length of an ejected droplet. More specifically, the meniscus of the liquid formed between the protrusions 27 is more easily maintained than the meniscus of another portion. Thus, the tail of the droplet extending from the ejection port 13 can be cut earlier, thus suppressing the formation of a satellite (mist), which is a minute droplet accompanying the main droplet. The contraction of the bubble narrows the trailing end portion in the ejection direction of the ejected droplet that has moved toward the central portion of the recording element 15, and narrows the tail. This can advance the timing of the air communication and shorten the tail length, thus suppressing the formation of a satellite due to the separation of a droplet from the main droplet. Even if a satellite separated from the main droplet is formed, due to the short tail length, the satellite is small and can be reduced in number. In FIGS. 1 to 14H, the ejection port 13 may be depicted without the protrusions 27. A wide interval 28 between the protrusions tends to result in an ejected droplet with a long tail length and a small satellite. Thus, the interval 28 is desirably 7.0 μm or less, more desirably 5.0 μm or less. The present inventors have found that, for example, when the ejection liquid has a viscosity of 0.002 Pa·s or more and 0.010 Pa·s or less and a surface tension of 20 mN/m or more and 60 mN/m or less, the time required for the air communication of the bubble B is likely to be influenced by the shortest interval between the protrusions. It has also been found that the time required for bubbles to communicate with the atmosphere is particularly short when the protrusions have the shortest interval of 5.0 μm or less. On the other hand, an excessively narrow interval may make it difficult to form the protrusions or may result in two separated ejected droplets. Thus, the interval 28 is desirably 2.0 μm or more. Thus, the interval 28 is desirably 2.0 μm or more and 7.0 μm or less, more desirably 2.0 μm or more and 5.0 μm or less. In the present embodiment, as an example, the interval 28 is 3.0 μm.

Furthermore, the protrusions 27 with a thick tip (on the center F side) may result in two ejected droplets divided by the protrusions 27. Thus, the leading edge of each protrusion 27 desirably has a width 271 of 4.0 μm or less, for example, 2.0 μm in the present embodiment. When each protrusion has a rounded tip as in the present embodiment illustrated in FIG. 15A, the width 271 of the leading edge can be defined as the length of a line segment between intersection points of a line perpendicular to the straight line L at the tip of the protrusion and two extended lines of the two long sides of the protrusion, as indicated by the dotted line in the drawing. Furthermore, to increase the strength of the protrusions 27, the width 272 of the basal portion of each protrusion 27 is desirably larger than that of the leading edge and is, for example, 4.0 μm in the present embodiment. As in the present embodiment illustrated in FIG. 15A, when the ejection port 13 at the basal portion has a curved shape, as indicated by the dotted line in the drawing, the width 272 of the basal portion can be defined as the length of a line segment between two intersection points of two extended lines of the two long sides of the protrusion and a circumferential line of the ejection port 13 if the ejection port 13 is a circle. Thus, from the perspective of droplet formation, the protrusions 27 can have a shape in which the width decreases from the basal portion toward the leading edge, and may have an arc shape as illustrated in FIG. 15B.

It is desirable that the two protrusions 27 extend in a direction approximately parallel to the conveying direction (X direction) of the record medium 2. Since the protrusions 27 have a very large influence on the ejection of a droplet, a slight variation in the shape of the two protrusions during production results in a droplet flying off in the direction of one of the protrusions and a landing position deviation. In general, a landing position deviation in the ejection port array direction (Y direction) is more easily visually recognized on the image than a landing position deviation in the conveying direction of the record medium (X direction). Thus, making the direction of the protrusions approximately parallel to the conveying direction of the record medium 2 can suppress the deviation in the ejection port array direction and has an effect of maintaining good printing. Furthermore, it is desirable that the protrusions 27 extend in the flow direction of the liquid near the pressure chamber. In other words, it is desirable that the straight line L on which the protrusions are positioned forms an angle of 45 degrees or less with the channel axis connecting the liquid supply channel 18 and the liquid collecting channel 19 or connecting the inlet channel 24a and the outlet channel 24b.

Although the two protrusions 27 extend toward the center F of the ejection port in the present embodiment, even one protrusion 27 can maintain good droplet formation. In such a case, however, the landing may be largely deviated in a direction in which the protrusion 27 is not present, and the landing position may be less consistent. Thus, it is more desirable that the two protrusions 27 extend in the direction of the ejection port center F. The present disclosure can be suitably applied even to a liquid ejection head having an ejection port without the protrusions 27.

It is desirable that the ejection port 13 have an opening area of 100 μm² or more. Alternatively, when the diameter of a circle with an area equal to the actual area of the ejection port 13 is defined as the effective diameter, the ejection port 13 desirably has an effective diameter of 11 μm or more. An excessively small opening area results in an increase in forward resistance during liquid ejection and a longer time required for air communication. This may increase the tail length and the number of satellites.

Furthermore, the opening area of the ejection port 13 affects the ejection speed of a droplet from the ejection port 13 described later. It should be noted that an ejection port with a protrusion tends to have a smaller opening area and a lower ejection speed than an ejection port with the same diameter and without the protrusions.

Conditions during Droplet Formation

Furthermore, to achieve stable ejection quality and high recording quality, it is desirable that the dot size of a landed droplet on the record medium 2 be relatively small and high definition. Thus, the liquid ejection head of the present embodiment has a relatively small ejection volume of 2.0 ng.

Droplet formation is also affected by the ejection speed of the droplet. At an excessively high ejection speed, the tip of the main droplet is ejected ahead of the tail, and the tail is likely to break and form a satellite. Thus, the ejection speed is desirably 12 m/s or less. On the other hand, at an excessively low droplet ejection speed, a component in the ejection liquid may burn and stick to the heating element. Thus, the ejection speed is desirably 7.0 m/s or more.

In an ink jet recording apparatus used in the commercial and industrial sectors or the like that require better droplet formation, an ink with a high solid density is used in some cases from the perspective of image fastness, color developability, or the like. The term “solid density”, as used herein, refers to the density of the pigment, resin, wax, and the like in the ejection liquid. At this time, defective ejection caused by the concentration of ink due to the evaporation of water from the ink may be more significant. Although the ejection speed can be increased to suppress the concentration of ink, at an excessively high ejection speed, the tail is easily broken, and a satellite is likely to occur, as described above. In the liquid ejection head of the present embodiment, since the liquid inside the pressure chamber can be circulated, even if water near the ejection port 13 evaporates, unevaporated fresh liquid is supplied from the inlet channel 24a. Thus, even when the ejection liquid is an ink with a high solid density, stable ejection can be realized without excessively increasing the ejection speed. The ink with a high solid density is, for example, an ink with a nonvolatile solvent concentration adjusted to 10% by weight or more and 20% by weight or less, a pigment concentration adjusted to 3% by weight or more and 10% by weight or less, a solid density adjusted to 10% by weight or more and 30% by weight or less, and a viscosity adjusted to 0.003 Pa·s or more and 0.006 Pa·s or less.

### Description of Embodiments of Present Disclosure

### First Embodiment

A first embodiment of the present disclosure is described below. Functions and configurations similar to those of the basic configuration described above are not described here, and different points are described.

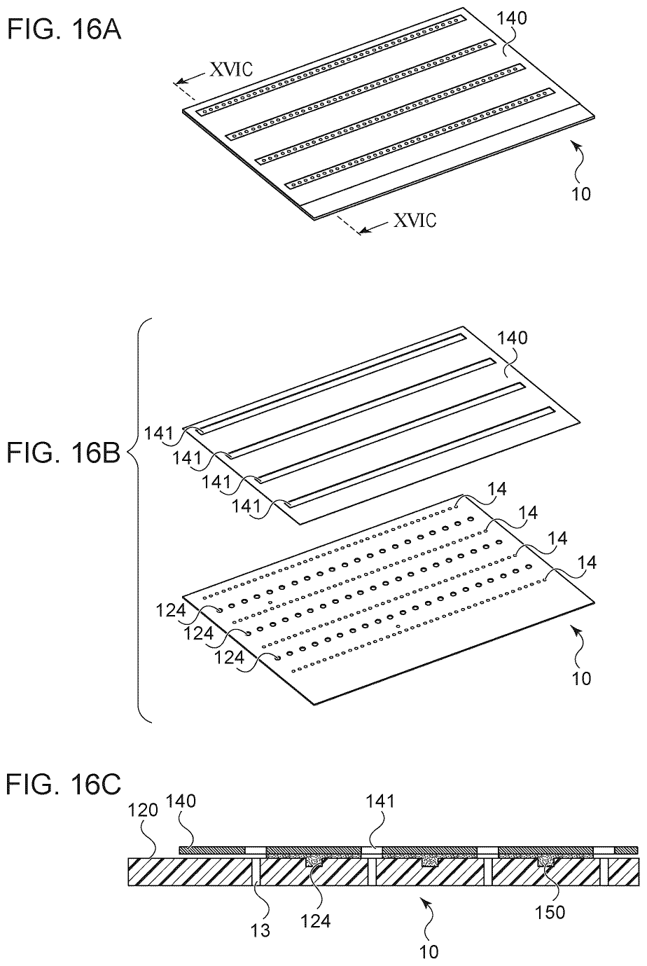

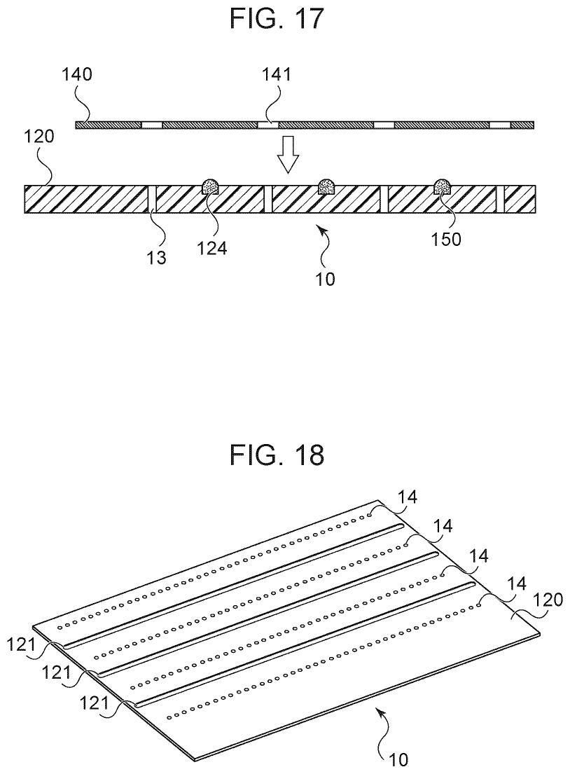

FIG. 16A is a perspective view of a simplified ejection module 200 according to the first embodiment. FIG. 16B is an exploded perspective view of FIG. 16A. FIG. 16C is a cross-sectional view taken along the line XVIC-XVIC of FIG. 16A. FIG. 17 is a schematic view of the adhesive agent application state in FIG. 16C. In FIGS. 16A, 16B, 16C, and 17, the configuration is partially simplified for the sake of clarity.

The first embodiment is different from the basic configuration in that a protective member 140 is disposed on the surface (ejection surface 120) of the channel-forming member 12. More specifically, as illustrated in FIGS. 16B and 16C, an opening 141 corresponding to an ejection port array 14 is formed in the protective member 140, and a depressed portion 124 is formed between adjacent ejection port arrays 14 on the ejection surface 120. The ejection surface 120 and the protective member 140 are bonded to each other by an adhesive agent 150 applied to the depressed portion 124. In such a configuration, the protective member 140 is located on the outermost surface of the liquid ejection head 3 in the liquid ejection direction. Thus, in the direction perpendicular to the head face, the ejection port 13 is located closer to the pressure chamber than the head face, which is the outermost surface of the liquid ejection head 3. Thus, mist and the like flying from the outside adhere preferentially to the protective member 140, which is the outermost surface, and this can suppress mist adhesion to the ejection port 13 and prevent an ink or a reaction liquid from adhering to the ejection port 13. This improves the ejection stability of the ink or the reaction liquid. To cause the mist to adhere to the protective member 140 earlier than the ejection surface 120, the thickness of the protective member 140 in the liquid ejection direction is preferably 1.0 μm or more, more preferably 10 μm or more. The shortest distance between the ejection port 13 and the protective member 140 in the direction parallel to the ejection surface 120 (hereinafter also referred to as the “in-plane direction”) is preferably 1.0 mm or less, more preferably 300 μm or less. This is because when the shortest distance is 1.0 mm or more, the protective member 140 is too far away from the ejection port 13, and the probability that the mist adheres to the ejection port 13 increases.

Furthermore, the protective member 140 is disposed on the ejection surface 120 and serves to prevent the record medium 2 and the element substrate 10 from coming into contact with each other when the record medium 2 is lifted during conveyance, reducing the risk of damage to the liquid ejection head 3. The record medium 2 may be an offset printing sheet or the like, which may contain mineral particles, such as silica or calcium carbonate, in a coating layer. A collision during conveyance causes these particles to fall off, and friction damages the ejection surface. These minerals have an elastic modulus of tens of gigapascals or more, and the protective member therefore also preferably has an elastic modulus of 50 GPa or more. For example, a metallic material, such as stainless steel, titanium, or aluminum, silicon, or alumina can be suitably used as a material. The length of the opening 141 of the protective member 140 in a direction approximately perpendicular to the ejection port array direction is preferably 250 μm or more and shorter than the interval between the adjacent ejection port arrays 14, and the protective member 140 preferably has a thickness of less than 50 μm. At this time, the distance between the head face and the ejection port 13 in the direction perpendicular to the head face is preferably 1.0 μm or more and 50 μm or less. In doing so, when a cleaning mechanism (not shown) of the apparatus 1000 comes into contact with the liquid ejection head 3 during maintenance at the time of recording, the cleaning mechanism (not shown) can more suitably collect the liquid in the liquid ejection head 3. Thus, the external shape of the protective member 140 and the opening 141 can be processed with high precision, for example, by a processing method, such as etching, laser processing, or press working.

As illustrated in FIG. 17, the adhesive agent 150 is applied to the depressed portion 124. The adhesive agent applied to the depressed portion 124 can have higher adhesive strength than the adhesive agent applied to a flat surface portion of the ejection surface 120. At this time, the ejection surface 120 can repel the liquid ejected from the ejection port 13, and the depressed portion 124 can have no repellency to the liquid. In doing so, the adhesive agent 150 is likely to remain in the depressed portion 124 and is less likely to flow into the ejection port 13. The adhesive agent 150 is suitably, for example, a thermosetting adhesive agent. Furthermore, to further increase the adhesive strength between the ejection surface 120 and the protective member 140, a method of forming an adhesive layer (not shown) on at least the ejection surface 120 side of the protective member 140 can also be suitably used.

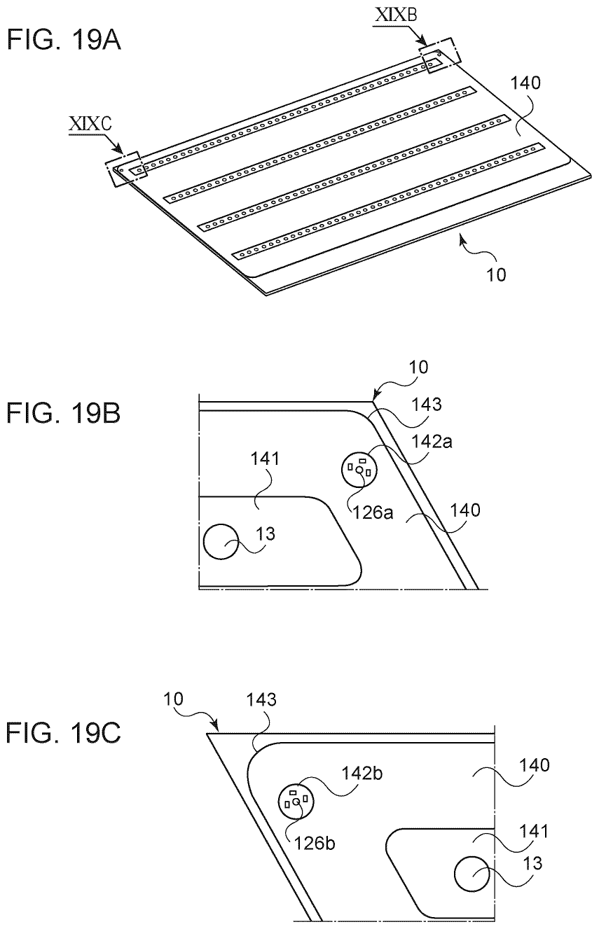

FIG. 18 is a perspective view of a simplified element substrate 10 as a modification example of FIG. 16B. FIG. 19A is a perspective view of a simplified ejection module 200 as a modification example of FIG. 16A. FIG. 19B is an enlarged view of a portion indicated by XIXB in FIG. 19A. FIG. 19C is an enlarged view of a portion indicated by XIXC in FIG. 19A. In FIGS. 18, 19A, 19B, and 19C, the configuration is partially simplified for the sake of clarity. As a modification example of the first embodiment, as illustrated in FIG. 18, the depressed portions 124 formed between the adjacent ejection port arrays 14 may be connected to each other in a groove shape. Such a configuration can further increase the adhesive strength between the ejection surface 120 and the protective member 140. Furthermore, as another modification example of the first embodiment, as illustrated in FIGS. 19A, 19B, and 19C, an R shape 143 may be formed at a corner portion of the protective member 140. Such a configuration can reduce the risk of damage to a cleaning mechanism (not shown) of the apparatus 1000 due to a corner portion of the protective member 140 when the cleaning mechanism (not shown) comes into contact with the liquid ejection head 3 during maintenance at the time of recording. Furthermore, to remove alignment marks 126a and 126b used for positioning between adjacent element substrates 10, openings 142a and 142b for removing a pattern may be formed in the protective member 140. Furthermore, a notch (not shown) may be formed in the protective member 140 in accordance with a pattern on the element substrate, such as an element substrate number (not shown) used for identifying the element substrate 10. At that time, the risk of damage to a cleaning mechanism (not shown) can be reduced by forming an R shape in the notch (not shown).

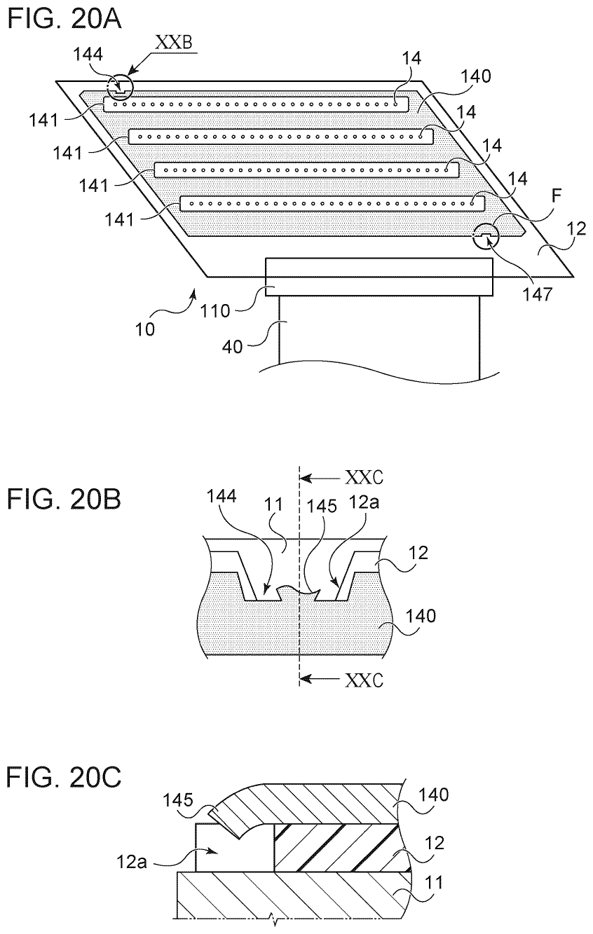

FIGS. 20A to 20C are schematic views of a modification example of the ejection module 200 illustrated in FIGS. 16A to 16C. The protective member 140 of the modification example illustrated in FIGS. 20A to 20C has a depressed portion and a protrusion portion inside the depressed portion. The protective member 140 of the modification example is described in detail below with reference to FIGS. 20A to 23E.

FIG. 20A is a schematic view of a simplified ejection module. FIG. 20B is an enlarged view of a portion indicated by XXB in FIG. 20A. FIG. 20C is a cross-sectional view taken along the line XXC-XXC of FIG. 20B.

In a manufacturing process of the protective member 140, a plurality of protective members are formed on one sheet, and the plurality of protective members are connected to each other via a connection portion. Then, for example, the connection portion is separated by vibration to provide one protective member. At this time, when the connection portion is separated, a protrusion portion is unfortunately formed in the protective member 140 in a direction perpendicular to the ejection port array 14 of the element substrate 10.

In view of this, the protective member 140 according to the present modification example is provided with at least one depressed portion 144 at an end portion parallel to the direction of the ejection port array 14 in the direction perpendicular to the ejection port array 14 of the element substrate 10 and with a protrusion portion 145 protruding in the direction perpendicular to the ejection port array 14 of the element substrate 10. The protrusion portion 145 is provided inside the depressed portion 144 of the protective member 140. Consequently, the protrusion portion 145 is provided within the formation region of the protective member 140 without protruding from the protective member 140.

Furthermore, as illustrated in FIG. 20C, the channel-forming member 12 is provided with a depressed portion 12a so as to correspond to the protrusion portion 145 of the protective member 140 in the direction perpendicular to the ejection port array 14 of the element substrate 10 and in the vertical direction. The depressed portion 12a of the channel-forming member 12 is formed so as to expose the substrate 11 on the lower side in the vertical direction. The protrusion portion 145 of the protective member 140 is accommodated in the depressed portion 12a of the channel-forming member 12. Consequently, the protrusion portion 145 is accommodated in the depressed portion 12a and does not come into contact with the ejection surface 120, and floating of the protective member 140 can therefore be suppressed.

The protective member 140 may have the depressed portion 144 (first depressed portion) at an end portion parallel to the ejection port array direction in the direction perpendicular to the ejection port array 14 of the element substrate 10 and may have a depressed portion 147 (second depressed portion) at another end portion opposite the end portion. The depressed portion 144 at the end portion and the depressed portion 147 at the other end portion are formed at the same position as the depressed portion 12a. Consequently, the depressed portion 12a is provided so as to correspond to the protrusion portion 145 of the protective member 140, can accommodate the protrusion portion 145, and can suppress the floating of the protective member 140.

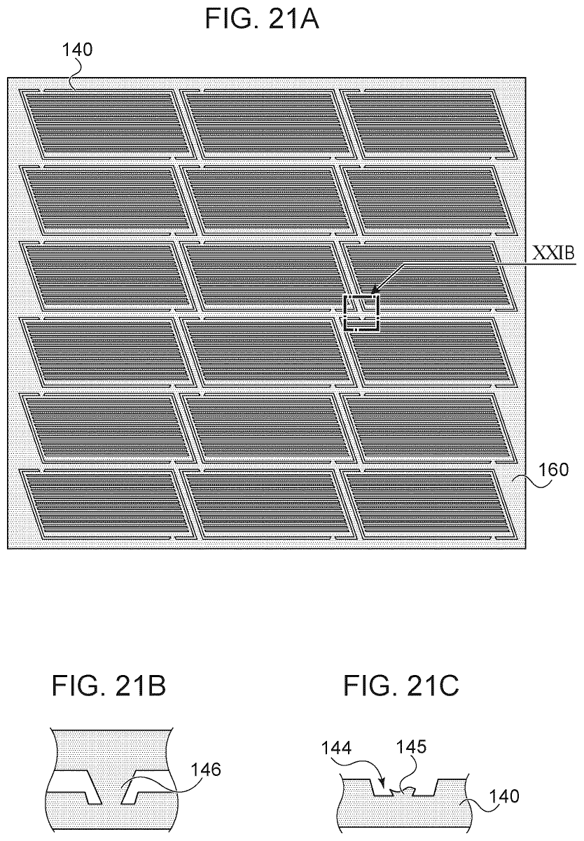

FIG. 21A is a plan view in which a plurality of protective members of a liquid ejection head according to the present disclosure are formed into one sheet shape, and FIG. 21B is an enlarged view of a portion XXIB of FIG. 21A. FIG. 21C is a partial enlarged view of the protective member 140 after being separated from the sheet, and corresponds to FIG. 21B.

In the protective member 140 of the present embodiment, to reduce the cost, the protective member 140 has a thickness of 50 μm or less, and a plurality of protective members 140 are formed by etching one large material sheet 160 so as not to form a burr in the opening 141 and the like.

As illustrated in FIG. 21B, the plurality of protective members 140 are connected to each other via a connection portion 146. The sheet 160 is vibrated for separation at the connection portion 146 and consequently forms the protrusion portion 145 in a direction in which the protective member 140 is approximately perpendicular to the ejection port array direction, as illustrated in FIG. 21C. The shape of the connection portion 146 may be tapered so as to narrow toward the protective member 140 or may be tapered so as to widen toward the protective member 140. The connection portion 146 can have a shape tapered so as to become narrower toward the protective member 140 but may have a shape in which the width of the connection to the protective member 140 is shorter. This can facilitate separation by vibration at the connection portion 146. Furthermore, in the shape in which the width of the connection to the protective member 140 is shorter, the depressed portion 12a of the channel-forming member 12 can be formed to be small.

Although the protective member 140 can be produced at low cost by separation by vibration as described above, the present inventors have found that the vibration may twist the protrusion portion 145 and deform the protrusion portion 145 upward or downward in the vertical direction.

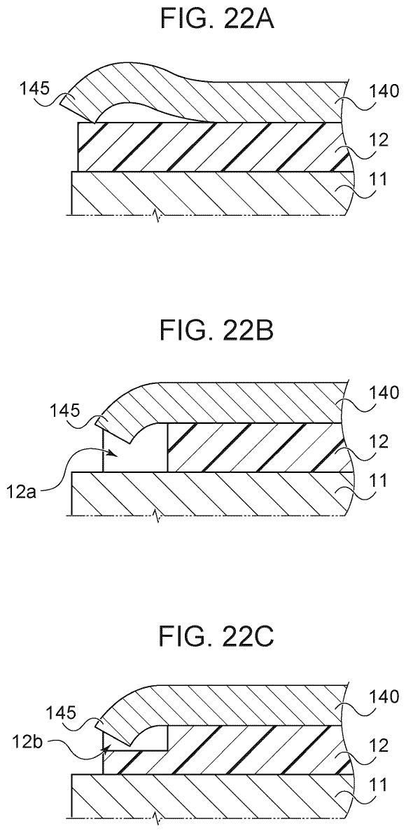

FIGS. 22A to 22C are a schematic cross-sectional view of an element substrate different from the present embodiment, a cross-sectional view of an element substrate 10 according to the present modification example, and a cross-sectional view illustrating the modification example.

A case where the protrusion portion 145 of the protective member 140 is deformed upward in the vertical direction is described below. Since there is a risk that a cleaning mechanism (not shown) of the apparatus 1000 comes into contact with the protrusion portion 145 and is damaged and broken during maintenance at the time of recording, it is desirable that the protrusion portion 145 be provided at a position that does not come into contact with the cleaning mechanism.

In the present embodiment, the sealant (sealing portion) 110 (see FIG. 20A), which is a connection portion between the substrate 11 and the flexible printed circuit board 40, is higher than the element substrate 10 in the vertical direction, and the cleaning mechanism is driven in the ejection port array direction to avoid the sealing portion 110 and the like. The protrusion portion 145 is provided at positions indicated by XXB and F in FIG. 20A on a side of the protective member 140 parallel to the ejection port array by etching or the like in a manufacturing process so as not to come into contact with the cleaning mechanism.

When the protrusion portion 145 of the protective member 140 is deformed downward in the vertical direction, as illustrated in FIG. 22A, the protrusion portion 145 may interfere with the ejection surface 120, and the protective member 140 may be deformed and lifted. When the area from an end portion of the protective member 140 to the opening 141 of the protective member 140 is large, the floating is suppressed by the rigidity of the member of the protective member 140. However, when the area from an end portion of the protective member 140 to the opening 141 of the protective member 140 is small, the floating is likely to occur. As in the present embodiment, the protrusion portion 145 may be formed on the side opposite the sealing portion 110 (see FIG. 20A) of the element substrate 10. In such a case, the area from an end portion of the protective member 140 to the opening 141 of the protective member 140 is small, and the deformation of the protrusion portion 145 downward in the vertical direction is therefore likely to lift the protective member during interference with the ejection surface 120.

Thus, in the present embodiment, as illustrated in FIG. 22B, the channel-forming member 12 has the depressed portion 12a so that the deformation of the protrusion portion 145 does not interfere with the ejection surface 120. Consequently, even when the protrusion portion 145 is deformed downward in the vertical direction, the protrusion portion 145 and the ejection surface 120 do not interfere with each other, and the floating of the protective member 140 can therefore be suppressed.

In the channel-forming member 12 of the present embodiment, when an ejection port and a pressure chamber are formed on the substrate 11, the channel-forming member 12 has the depressed portion 12a at a position corresponding to the protrusion portion 145 and is formed such that the surface of the substrate 11 is exposed. The exposed portion of the surface of the substrate 11 is located opposite the sealing portion 110, and a main circuit is not provided inside the substrate and is therefore less likely to be affected by electrical noise from the exposed portion of the substrate 11.

Furthermore, as illustrated in FIG. 22C, the channel-forming member 12 may have a depressed portion 12b so that the substrate 11 is not exposed. This reduces the height of the depressed portion in the vertical direction and reduces the distance between the protrusion portion 145 and the channel-forming member 12 as compared with the depressed portion 12a where the surface of the substrate 11 is exposed. However, the substrate 11 is covered with the protective member 140, and resistance to electrical noise is therefore increased.

In the present embodiment, the protrusion portion 145 is formed by cutting off the connection between the material sheet and the protective member 140, but the protrusion portion 145 may also be provided on the side of the protective member 140 opposite the side on which the protrusion portion 145 is formed. As illustrated in FIG. 20A, the protrusion portion 145 is provided on the sealing portion 110 side of the protective member 140 (see the region F in FIG. 20A). The element substrate 10 has a long distance from the ejection port array 14 closest to the sealing portion 110 side of the element substrate 10 to the end portion of the channel-forming member 12 near the sealing portion 110 to route the wiring in the substrate from the sealing portion 110 side toward the ejection port array. Thus, when the protective member 140 is disposed on the element substrate 10, it is possible to increase the area of the protective member 140 on the sealing portion 110 side. If a depressed portion corresponding to the protrusion portion 145 is provided at a position indicated by the region F in FIG. 20A, the floating of the protective member 140 can be further suppressed. On the other hand, if the depressed portion is not provided, electrical noise contamination due to exposure of the substrate 11 can be suppressed.

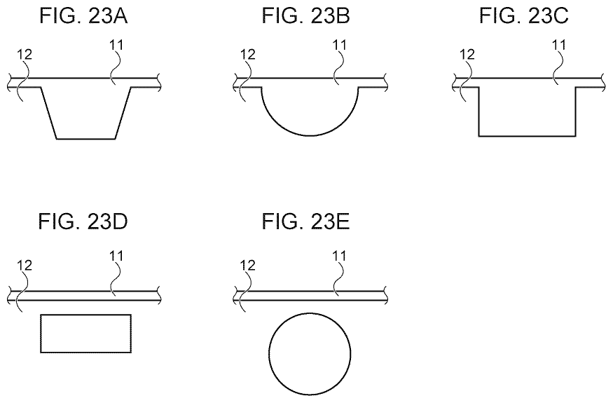

The depressed portion of the channel-forming member 12 may have any shape that does not interfere with the ejection surface 120 when the protrusion portion 145 of the protective member 140 is deformed downward in the vertical direction. For example, as illustrated in FIGS. 23A to 23C, the depressed portion 12b may have a trapezoidal shape, a semicircular shape, or a rectangular shape. Furthermore, without being limited to the depressed portion, an opening portion capable of accommodating the protrusion portion 145 may be provided. For example, as illustrated in FIGS. 23D and 23E, a quadrangular opening portion or a circular opening portion may be provided. The protrusion portion 145 can be accommodated in each provided opening portion. These can suppress the floating of the protective member 140 due to interference between the protrusion portion 145 of the protective member 140 and the ejection surface 120.

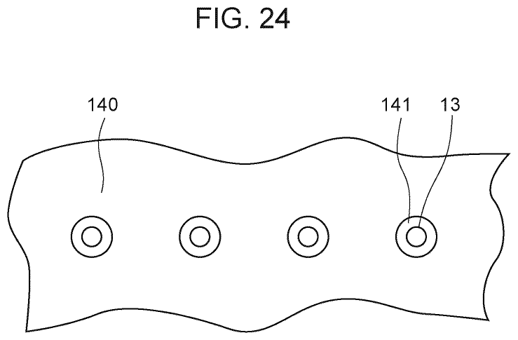

Although one ejection port array 14 is provided in one opening 141 of the protective member 140 in the above example, the configuration of the present disclosure is not limited thereto. As in the enlarged view of the vicinity of the ejection port 13 illustrated in FIG. 24, the protective member 140 may have one opening 141 for one ejection port 13. This one-to-one correspondence between the ejection port 13 and the opening 141 can enhance the effect of suppressing mist adhesion near the ejection port 13.

### Second Embodiment

A second embodiment of the present disclosure is described below. Functions and configurations similar to those of the first embodiment are not described here, and different points are described.

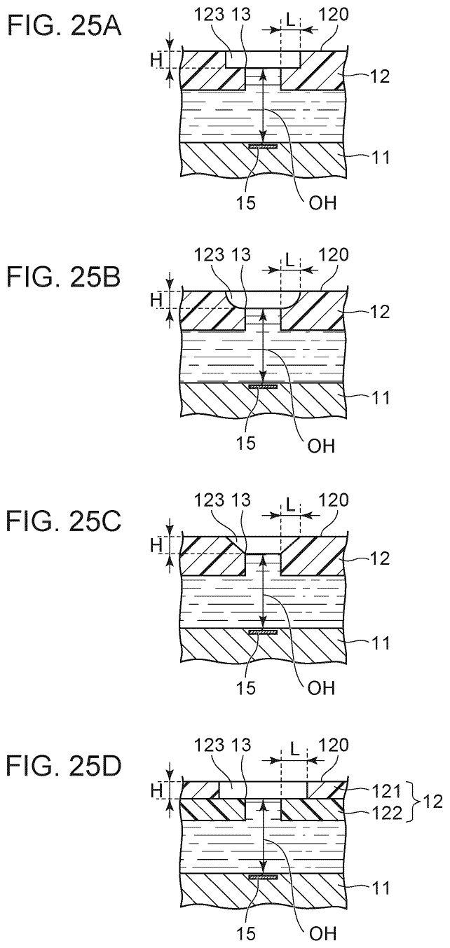

FIG. 25A is a cross-sectional view in the direction perpendicular to the head face passing through the center of the ejection port 13 in the second embodiment.

In the second embodiment, on the ejection surface 120 side of the channel-forming member 12, which is an head face, a depressed portion 123 with a height difference between the vicinity of the ejection port 13 and the other portion is provided, and the ejection port 13 is positioned inside the depressed portion 123. More specifically, in the direction perpendicular to the head face, the ejection port 13 is located closer to the pressure chamber 23 than the ejection surface 120 of the channel-forming member 12. Thus, the ejection port 13 is located closer to the pressure chamber 23 than the head face, which is the outermost surface of the liquid ejection head 3. With such a configuration, mist and the like flying from the outside adhere preferentially to the ejection surface 120, and this can suppress mist adhesion to the ejection port 13 and prevent an ink or a reaction liquid from adhering to the ejection port 13. This improves the ejection stability of the ink or the reaction liquid. To cause the mist to adhere to the ejection surface 120 earlier than the ejection port 13, the height difference H between the ejection surface 120 and the ejection port 13 in the ejection direction is preferably 1.0 μm or more.

The shortest distance L between the ejection port 13 and the ejection surface 120 in the direction parallel to the ejection surface is preferably 1.0 mm or less, more preferably 300 μm or less. This is because a shortest distance L of 1.0 mm or more results in the ejection surface 120 too far from the ejection port 13 and increases the probability that the mist adheres to the ejection port 13.

The shape and configuration of the depressed portion 123 in the ejection port 13 of the channel-forming member 12 may be any shape as long as the ejection port 13 is located closer to the pressure chamber 23 than the ejection surface 120. It may be a curved surface as illustrated in FIG. 25B, or may be an inclined surface as illustrated in FIG. 25C. Furthermore, as illustrated in FIG. 25D, in the channel-forming member 12 with a layered structure, the depressed portion 123 may be formed by making the opening size near the ejection port 13 different in each layer.

Furthermore, the ejection surface of the channel-forming member 12 may be recessed toward the pressure chamber 23 in each ejection port 13, or a plurality of ejection ports 13 may be disposed in one depressed portion. One-to-one correspondence between the ejection port 13 and the depressed portion 123 can enhance the effect of suppressing mist adhesion near the ejection port 13.

### (2) Reaction Liquid

Components and the like used in an aqueous reaction liquid of the present disclosure are described in detail below.

### Reactant

The reaction liquid comes into contact with an ink, reacts with the ink, and aggregates a component (a component with an anionic group, such as a resin or a self-dispersible pigment) in the ink, and contains a polyvalent metal salt, an organic acid, a cationic resin, or the like as a reactant. Any reactant can be added to the reaction liquid as long as desired characteristics, such as high storage stability of the reaction liquid, high intermittent ejection stability, and suppression of image unevenness, can be achieved.

In a reaction liquid containing a polyvalent metal salt, the polyvalent metal salt, which is a compound produced by bonding a divalent or higher-valent metal ion and an anion, is dissociated into a polyvalent metal ion in the reaction liquid and can aggregate a coloring material dispersed by the action of an anionic group contained in the ink.

The polyvalent metal ion is, for example, a divalent metal ion, such as Ca²⁺, Cu²⁺, Ni²⁺, Mg²⁺, Sr²⁺, Ba²⁺, or Zn²⁺, or a trivalent metal ion, such as Fe³⁺, Cr³⁺, Y³⁺, or Al³⁺. To contain a polyvalent metal ion in the reaction liquid, a polyvalent metal salt (which may be a hydrate) produced by bonding the polyvalent metal ion and an anion can be used. The anion is, for example, an inorganic anion, such as Cl−, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻, or H₂PO₄⁻; or an organic anion, such as HCOO⁻, (COO⁻)₂, COOH(COO⁻), CH₃COO⁻, C₂H₅COO⁻, CH₃CH(OH)COO⁻. C₂H₄(COO⁻)₂, C₆H₅COO⁻, C₆H₄(COO⁻)₂, or CH₃SO₃⁻. The polyvalent metal salt content (% by mass) of the reaction liquid is preferably 1.0% by mass or more and 20.0% by mass or less, more preferably 1.0% by mass or more and 5.0% by mass or less, based on the total mass of the reaction liquid.

The polyvalent metal salt preferably has a water solubility (g/100 mL) of 25.0 g/100 mL or more at 25° C. A polyvalent metal salt with a water solubility of less than 25.0 g/100 mL tends to have an unstable dissolution state in the reaction liquid and tends to precipitate. A precipitated polyvalent metal salt may decrease the reactivity with the ink, and image unevenness therefore cannot be sufficiently suppressed in some cases. The solubility is preferably 50.0 g/100 mL or less.

A reaction liquid containing an organic acid has buffering capacity in an acid region (pH of less than 7.0, preferably pH in the range of 2.0 to 5.0), efficiently converts an anionic group of a component present in the ink into an acid form, and aggregates the component. The organic acid is, for example, a monocarboxylic acid, such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid, or coumaric acid, or a salt thereof; a dicarboxylic acid, such as oxalic acid, malonic acid, succinic acid, glutaric acid, adipic acid, maleic acid, fumaric acid, itaconic acid, sebacic acid, phthalic acid, malic acid, or tartaric acid, or a salt or hydrogen salt thereof; a tricarboxylic acid, such as citric acid or trimellitic acid, or a salt or hydrogen salt thereof; or a tetracarboxylic acid, such as pyromellitic acid, or a salt or hydrogen salt thereof. When the organic acid is added, the organic acid content (% by mass) of the reaction liquid is preferably 1.0% by mass or more and 50.0% by mass or less based on the total mass of the reaction liquid.

The cationic resin is, for example, a resin with a primary to tertiary amine structure or a resin with a quaternary ammonium salt structure. Specific examples thereof include resins, such as vinylamine, allylamine, vinylimidazole, vinylpyridine, dimethylaminoethyl methacrylate, ethyleneimine, guanidine, diallyldimethylammonium chloride, or an alkylamine-epichlorohydrin condensate. To increase the solubility in the reaction liquid, a cationic resin and an acidic compound may be used in combination, or the cationic resin may be subjected to a quaternary treatment. When a cationic resin is added, the cationic resin content (% by mass) of the reaction liquid is preferably 0.1% by mass or more and 10.0% by mass or less based on the total mass of the reaction liquid.

### Surfactant

The reaction liquid contains a nonionic surfactant with an HLB value of 14 or less. To further suppress image unevenness, the nonionic surfactant preferably has an HLB value of 12 or less. The “HLB value” of the nonionic surfactant in the present specification is a value determined by the Griffin method and is calculated based on the formula: HLB value=20×(formula weight of hydrophilic group of surfactant)/(molecular weight of surfactant). The HLB determined by the Griffin method is a physical property indicating the hydrophilicity or lipophilicity of the nonionic surfactant and ranges from 0 to 20. A lower HLB indicates higher lipophilicity, and a higher HLB indicates higher hydrophilicity. The nonionic surfactant preferably has an HLB value of 4 or more.

The nonionic surfactant may be a hydrocarbon, fluorinated, or silicone surfactant. The nonionic surfactant can be at least one selected from the group consisting of a hydrocarbon surfactant and a silicone surfactant. This is because such a surfactant has a high ability to wet and spread easily on a record medium due to the structure thereof and has action not easily impaired even when evaporation or the like changes the composition of the reaction liquid.

The hydrocarbon nonionic surfactant is, for example, a polyoxyethylene alkyl ether, an ethylene oxide adduct of acetylenic glycol, a poly(ethylene glycol)-poly(propylene glycol) block copolymer, or an ethylene oxide adduct of a polyhydric alcohol. The fluorinated nonionic surfactant is, for example, a perfluoroalkyl ethylene oxide adduct. The silicone nonionic surfactant is, for example, a polyether modified siloxane compound. In particular, both a hydrocarbon nonionic surfactant and a silicone nonionic surfactant can be used. When these are used in combination, the hydrocarbon nonionic surfactant content can be higher than the silicone nonionic surfactant content. The nonionic surfactant content (% by mass) of the reaction liquid is preferably 0.1% by mass or more and 4.0% by mass or less, more preferably 0.2% by mass or more and 2.0% by mass or less.

The ink may further contain various surfactants (other surfactants) other than the nonionic surfactant. The other surfactants may be an anionic surfactant, a cationic surfactant, and an amphoteric surfactant. The other surfactants may be a hydrocarbon surfactant, a fluorinated surfactant, a silicone surfactant, and the like, with an HLB value outside the above range. The surfactant (the nonionic surfactant and the other surfactants in total) content (% by mass) of the reaction liquid is preferably 0.1% by mass or more and 5.0% by mass or less, more preferably 0.2% by mass or more and 3.0% by mass or less, based on the total mass of the reaction liquid.

### Aqueous Medium

The reaction liquid contains an aqueous medium that is a mixed solvent of water and a water-soluble organic solvent. The water can be deionized water or ion-exchanged water. The water content (% by mass) of the reaction liquid is preferably 75.0% by mass or more based on the total mass of the reaction liquid. When the content is less than 75.0% by mass, the polyvalent metal salt may precipitate when a liquid component of the reaction liquid evaporates in continuous recording. Consequently, image unevenness may not be sufficiently suppressed. The water content (% by mass) of the reaction liquid is preferably 95.0% by mass or less based on the total mass of the reaction liquid.

The water solubility (g/100 mL) C of the polyvalent metal salt at 25° C., the polyvalent metal salt content (% by mass) c of the reactant liquid, and the water content (% by mass) W of the reactant liquid preferably satisfy the relationship W/(100×c/C)≥4.0. 100×c/C in the relational expression represents the amount of water (% by mass) required to dissolve the polyvalent metal salt. Thus, the relational expression means that the reaction liquid contains water in an amount of 4.0 times or more the amount of water required to dissolve the polyvalent metal salt. When the left side of the relational expression is less than 4.0 times, evaporation may make the dissolution of the polyvalent metal salt unstable, and the polyvalent metal salt may precipitate. Consequently, image unevenness may not be sufficiently suppressed.

The reaction liquid contains a first water-soluble organic solvent with an SP value of 14.8 or less and a second water-soluble organic solvent with an SP value of 14.8 or less and a vapor pressure of 1.0×10⁻³ kPa or more. In particular, a third water-soluble organic solvent with an SP value of 14.8 or less and a vapor pressure of 1.0×10⁻² kPa or more can be contained. When the third water-soluble organic solvent is contained, during long-term image recording, the third water-soluble organic solvent evaporates easily among the liquid components in the reaction liquid and can therefore more effectively suppress the change in the composition of the liquid components. Consequently, image unevenness can be more effectively suppressed. The water-soluble organic solvent in the reaction liquid may be only one type. In other words, the first water-soluble organic solvent, the second water-soluble organic solvent, and the third water-soluble organic solvent may be the same. The first water-soluble organic solvent preferably has a vapor pressure of 1.0×10⁻¹ kPa or less at 25° C. The first water-soluble organic solvent preferably has an SP value of 10.0 or more.

The water-soluble organic solvent satisfying these conditions may be propylene glycol (1,2-propanediol) (SP value: 13.5, vapor pressure: 1.8×10⁻² kPa), ethylene glycol (1,2-ethanediol) (SP value: 14.8, vapor pressure: 1.2×10⁻² kPa), 1,2-butanediol (SP value: 12.8, vapor pressure: 2.0×10⁻² kPa), 1,2-hexanediol (SP value: 11.8, vapor pressure: 2.6×10⁻³ kPa), diethylene glycol monoethyl ether (SP value: 10.8, vapor pressure: 1.7×10⁻² kPa), 2-methyl-1,3-propanediol (SP value: 14.8, vapor pressure: 3.0×10⁻³ kPa), or 2-pyrrolidone (SP value: 12.6, vapor pressure: 1.3×10⁻³ kPa). In particular, the first water-soluble organic solvent can contain a 1,2-alkanediol because image unevenness can be more efficiently suppressed. This is probably because it has a relatively small molecular weight, has a hydrophilic portion derived from the hydroxy group and a hydrophobic portion derived from the alkyl chain, and can function as a surfactant. The first water-soluble organic solvent can be a 1,2-alkanediol. In the present specification, the vapor pressure is a value at 25° C. and 1 atm.

The proportion (% by mass) of the second water-soluble organic solvent in the water-soluble organic solvent with an SP value of 14.8 or less in the reaction liquid is preferably 80.0% by mass or more. When the proportion is less than 80.0% by mass, evaporation is likely to change the orientation state of the surfactant, and image unevenness cannot be sufficiently suppressed in some cases. The proportion may be 100.0% by mass. The proportion (% by mass) of the third water-soluble organic solvent in the water-soluble organic solvent with an SP value of 14.8 or less in the reaction liquid is preferably 80.0% by mass or more. When the proportion is in the above range, a change in the orientation state of the surfactant due to evaporation can be further suppressed, and image unevenness can be efficiently suppressed. The proportion may be 100.0% by mass.

In the present specification, the SP value (δ) is a value calculated by the Fedors method based on the following formula. The unit of the SP value (δ) is ((cal/cm³)^{1/2}), although the unit is omitted in the present specification.

$$δ = {( Δ {E}_{vap} / V )}^{1 / 2}$$

(In the formula, ΔEᵥₐₚ denotes the molar heat of vaporization (cal/mol), and V denotes the molar volume (cc/mol) at 25° C.)

When the ink contains a plurality of water-soluble organic solvents, the SP value of the water-soluble organic solvents is calculated as an average SP value. The average SP value of the water-soluble organic solvents is calculated by multiplying the SP value of each water-soluble organic solvent by its proportion (% by mass) in the total amount of the water-soluble organic solvents in the ink and then summing the products.

### Resin

A reaction liquid according to the present disclosure contains a resin. The resin may be an acrylic resin, a urethane resin, or a urea resin. In particular, an acrylic resin can be used. The resin content (% by mass) of the reaction liquid is preferably 1.00% by mass or more and 25.00% by mass or less, more preferably 3.00% by mass or more and 15.00% by mass or less, based on the total mass of the reaction liquid. In particular, 5.00% by mass or more and 15.00% by mass or less is particularly preferred.

The resin can be contained in a reaction liquid and an ink described later to improve various characteristics of an image to be recorded, such as scratch resistance and hiding power. The resin may be a block copolymer, a random copolymer, a graft copolymer, or a combination thereof. The resin may be a water-soluble resin that can be dissolved in an aqueous medium or resin particles to be dispersed in an aqueous medium. The resin particles do not need to contain a coloring material.

In the present specification, the phrase “resin is water-soluble” means that, when neutralized with an alkali in an amount equivalent to the acid value, the resin is present in an aqueous medium without a particle with a particle size measurable by a dynamic light scattering method. Whether or not the resin is water-soluble can be determined by the following method. First, a liquid (resin solid content: 10% by mass) containing a resin neutralized with an alkali (sodium hydroxide, potassium hydroxide, or the like) equivalent to the acid value is prepared. The prepared liquid is then diluted 10 times (on a volume basis) with pure water to prepare a sample solution. When the particle size of the resin in the sample solution is measured by the dynamic light scattering method, if a particle with a particle size is not observed, the resin can be determined to be water-soluble. The measurement conditions can be, for example, SetZero: 30 seconds, number of measurements: 3, and measurement time: 180 seconds. A particle size analyzer using a dynamic light scattering method (for example, trade name “UPA-EX150”, manufactured by Nikkiso Co., Ltd.) can be used as a particle size distribution analyzer. As a matter of course, the particle size distribution analyzer to be used, the measurement conditions, and the like are not limited to those described above.

The water-soluble resin preferably has an acid value of 80 mgKOH/g or more and 250 mgKOH/g or less, more preferably 100 mgKOH/g or more and 200 mgKOH/g or less. Resin particles, if present, preferably have an acid value of 0 mgKOH/g or more and 50 mgKOH/g or less. The resin preferably has a weight-average molecular weight of 1,000 or more and 30,000 or less, more preferably 5,000 or more and 15,000 or less. The weight-average molecular weight of the resin is a polystyrene equivalent molecular weight measured by gel permeation chromatography (GPC).

### Other Components

If necessary, the reaction liquid may contain various other components.

The other components may be the other components that can be contained in an ink described later.

### Physical Properties of Reaction Liquid

A reaction liquid that can be suitably used in a recording method according to the present disclosure is an aqueous reaction liquid applied to an ink jet system. Thus, from the perspective of reliability, the physical properties thereof can be appropriately controlled. More specifically, the reaction liquid preferably has a surface tension of 20 mN/m or more and 60 mN/m or less at 25° C. The reaction liquid preferably has a viscosity of 1.0 mPa·s or more and 10.0 mPa·s or less at 25° C. The reaction liquid preferably has a pH of 5.0 or more and 9.5 or less, more preferably 6.0 or more and 9.0 or less, at 25° C.

### (3) Ink

An ink that can be used for an ink jet recording method according to the present disclosure is described in detail below with reference to embodiments. In the present disclosure, with respect to a salt compound, although the salt is dissociated into ions in ink, for convenience, it is expressed as “the salt is contained”. An aqueous ink jet ink may be referred to simply as an “ink”. Unless otherwise specified, physical properties are values at normal temperature (25° C.). For recording of an image using a white ink, the white ink may be used as an underlayer treatment of a chromatic color ink. In such a case, an image may be recorded by applying a chromatic color ink (an ink of black, cyan, magenta, yellow, or the like) so as to overlap at least part of the region to which the white ink has been applied. It can also be used for back print of applying a white ink so as to overlap at least part of the region to which a chromatic color ink has been applied.

An ink according to the present disclosure is an aqueous ink jet ink containing a coloring material dispersed by the action of an anionic group. An ink according to the present disclosure is not necessarily a so-called “curable ink”. Thus, an ink according to the present disclosure does not necessarily contain a polymerizable monomer that can be polymerized by external energy, such as heat or light, or the like. Components constituting an ink according to the present disclosure, physical properties of the ink, a method for producing the ink, and the like are described in detail below. Coloring Material

The ink contains a coloring material dispersed by an anionic action. The coloring material can be a pigment or dye. The coloring material content (% by mass) of the ink is preferably 0.1% by mass or more and 15.0% by mass or less, more preferably 1.0% by mass or more and 10.0% by mass or less, based on the total mass of the ink.

Specific examples of the pigment include inorganic pigments, such as carbon black and titanium oxide; and organic pigments, such as azo, phthalocyanine, quinacridone, isoindolinone, imidazolone, diketopyrrolopyrrole, and dioxazine.

In a method of dispersing the pigment, a resin-dispersed pigment containing a resin as a dispersant, a self-dispersible pigment with a hydrophilic group bonded to the surface of a pigment particle, or the like can be used. Furthermore, a resin-bonded pigment with an organic group containing a resin chemically bonded to the surface of a pigment particle, a microcapsule pigment in which the surface of a pigment particle is coated with a resin or the like, or the like can be used. In particular, rather than the resin-bonded pigment or the microcapsule pigment, a resin-dispersed pigment in which a resin serving as a dispersant is physically adsorbed on the surface of a pigment particle can be used. Thus, the pigment can be dispersed by a resin with an anionic group (a resin dispersant).

A resin dispersant for dispersing the pigment in an aqueous medium is a resin dispersant capable of dispersing the pigment in the aqueous medium by the action of an anionic group. The resin dispersant can be a resin described later, particularly a water-soluble resin. The pigment content (% by mass) of the ink is preferably 0.3 times or more and 10.0 times or less the resin dispersant content in terms of mass ratio.

The self-dispersible pigment can be a pigment with an anionic group, such as a carboxylic acid group, a sulfonic acid group, or a phosphonic acid group, bonded to the surface of a pigment particle directly or via another atomic group (—R—). The anionic group may be an acid type or a salt type. The salt type may be in a partially dissociated state or in an entirely dissociated state. When the anionic group is a salt type, a cation serving as a counter ion may be an alkali metal cation, ammonium, or an organic ammonium. Specific examples of the other atomic group (—R—) include a linear or branched alkylene group with 1 to 12 carbon atoms; an arylene group, such as a phenylene group or a naphthylene group; a carbonyl group; an imino group; an amide group; a sulfonyl group; an ester group; and an ether group. A combination of these groups may also be used.

The dye is a dye with an anionic group. Specific examples of the dye include azo, triphenylmethane, (aza) phthalocyanine, xanthene, and anthrapyridone. The coloring material can be a pigment or a resin-dispersed pigment.

### Coloring Material (White Ink)

The present disclosure can be suitably used for an ink jet recording method using an ink containing titanium oxide as a coloring material. The ink can be a white ink because titanium oxide is a white pigment. As in the present disclosure, as described above, a non-absorptive record medium formed of vinyl chloride (PVC), poly(ethylene terephthalate) (PET), or the like is often used in an ink jet recording method using an aqueous reaction liquid containing a reactant that reacts with an aqueous ink. In such a case, regardless of the color of the record medium, image recording with high color development can be achieved by using a white ink containing titanium oxide. A coloring material in a white ink containing titanium oxide is described below.

The white ink contains titanium oxide as a coloring material (pigment). The titanium oxide may be titanium oxide particles subjected to surface treatment with a specific inorganic oxide. Thus, an ink may contain titanium oxide particles with a surface coated with a specific inorganic oxide. The titanium oxide particle content (% by mass) of the ink is preferably 0.10% by mass or more and 20.00% by mass or less based on the total mass of the ink. The titanium oxide particle content (% by mass) of the ink is more preferably 1.00% by mass or more and 20.00% by mass or less based on the total mass of the ink. The titanium oxide particle content (% by mass) of the ink is particularly preferably 1.00% by mass or more and 15.00% by mass or less based on the total mass of the ink.

Titanium oxide is a white pigment and has three crystal forms of a rutile type, an anatase type, and a brookite type. In particular, rutile titanium oxide can be used. Titanium oxide may be industrially produced by a sulfuric acid method or a chlorine method, and titanium oxide used in the present disclosure may be produced by any method.

Titanium oxide particles preferably have a volume-based cumulative 50% particle size (hereinafter also referred to as an average particle size) of 200 nm or more and 500 nm or less. In particular, titanium oxide particles more preferably have a volume-based cumulative 50% particle size of 200 nm or more and 400 nm or less. The volume-based cumulative 50% particle size (D50) of titanium oxide particles is the diameter of a particle at an integrated value of 50% based on the total volume of particles measured from the smallest particle size in a cumulative particle size curve. D50 of titanium oxide particles can be measured under the conditions of, for example, SetZero: 30 seconds, number of measurements: 3, measurement time: 180 seconds, shape: non-spherical, and refractive index: 2.60. A particle size analyzer using a dynamic light scattering method can be used as a particle size distribution analyzer. As a matter of course, the measurement conditions and the like are not limited to the above.

Titanium oxide may be subjected to surface treatment with alumina and silica. The surface treatment is expected to reduce photocatalytic activity and improve dispersibility. The term “alumina”, as used herein, is a general term for oxides of aluminum, such as aluminum oxide. The term “silica”, as used herein, is a general term for silicon dioxide or a substance composed of silicon dioxide. The majority of alumina and silica that coat titanium oxide is present in the form of silicon dioxide and aluminum oxide.

The titanium oxide content (% by mass) of titanium oxide particles is preferably 90.00% by mass or more based on the total mass of the titanium oxide particles. The titanium oxide content (% by mass) of titanium oxide particles is preferably 98.50% by mass or less based on the total mass of the titanium oxide particles. The alumina content (% by mass) of titanium oxide particles needs to be 0.50 times or more and 1.00 time or less the silica content (% by mass) in terms of mass ratio. A mass ratio of less than 0.50 times or more than 1.00 time results in an ink with low ejection stability. The silica content (% by mass) of titanium oxide particles is preferably 1.00% by mass or more and 4.00% by mass or less of the total mass of the titanium oxide particles. A silica content (% by mass) of less than 1.00% by mass may result in an insufficient affinity for a compound represented by the general formula (1) and an ink with insufficient ejection stability. A silica content (% by mass) of more than 4.00% by mass may result in a significant amount of compound represented by the general formula (1) adsorbed on titanium oxide particles even surface-treated with alumina and may result in an ink with insufficient ejection stability. The alumina content (% by mass) of titanium oxide particles is preferably 0.50% by mass or more and 4.00% by mass or less based on the total mass of the titanium oxide particles.

The alumina and silica contents of titanium oxide particles, that is, the amounts of alumina and silica coating may be measured, for example, by the quantitative analysis of aluminum and silicon elements using inductively coupled plasma (ICP) emission spectrometry. In such a case, it can be calculated by converting the obtained values of aluminum and silicon into their oxides, that is, alumina and silica, on the assumption that all the atoms covering the surface are oxides. The aluminum element content (% by mass) of titanium oxide particles determined by inductively coupled plasma emission spectrometry is 0.57 times or more and 1.13 times or less the silicon element content (% by mass) in terms of mass ratio. When this value is converted into oxides thereof, that is, alumina and silica, the alumina content (% by mass) of titanium oxide particles is 0.50 times or more and 1.00 time or less the silica content (% by mass) in terms of mass ratio.

The surface treatment method for titanium oxide may be wet processing, dry processing, or the like. For example, titanium oxide can be dispersed in a liquid medium and then reacted with a surface treating agent, such as sodium aluminate or sodium silicate, for surface treatment, and the ratio of the surface treating agent can be appropriately changed for adjustment to desired characteristics. In addition to alumina and silica, an inorganic oxide, such as zinc oxide or zirconia, or an organic substance, such as a polyol, can be used for the surface treatment without losing the advantages of the present disclosure.

A white ink may contain a pigment other than titanium oxide without losing the advantages of the present disclosure. In such a case, an ink of a color other than white ink may be used. The other pigment content (% by mass) of an ink is preferably 0.10% by mass or more and 5.00% by mass or less, more preferably 0.10% by mass or more and 1.00% by mass or less, based on the total mass of the ink.

### Compound Represented by General Formula (1)

An ink can contain a compound represented by the following general formula (1) as a dispersant for dispersing titanium oxide particles. The amount (% by mass) of compound represented by the general formula (1) in the ink is preferably 0.01% by mass or more and 1.00% by mass or less, 0.02% by mass or more and 0.50% by mass or less, based on the total mass of the ink.

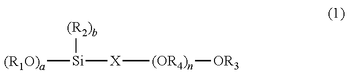

(In the general formula (1), R₁, R₂, and R₃ each independently denote a hydrogen atom or an alkyl group with 1 to 4 carbon atoms. R_{4S} each independently denote an alkylene group with 2 to 4 carbon atoms. X denotes a single bond or an alkylene group with 1 to 6 carbon atoms. n ranges from 6 to 24. a ranges from 1 to 3, b ranges from 0 to 2, and a+b=3)

In the general formula (1), R₁, R₂, and R₃ each independently denote a hydrogen atom or an alkyl group with 1 to 4 carbon atoms. The alkyl group with 1 to 4 carbon atoms may be a methyl group, an ethyl group, a n-propyl group, an i-propyl group, or a n-butyl group. In particular, a methyl group can be used from the perspective of ease of hydrolysis. When R₁, R₂, and R₃ each independently denote an alkyl group with more than 4 carbon atoms, it is difficult to form a silanol group by hydrolysis, and an affinity for titanium oxide particles cannot be obtained. Thus, titanium oxide particles cannot be stably dispersed, and the ink cannot have ejection stability. a that denotes the number of R₁O ranges from 1 to 3, b that denotes the number of R₂ ranges from 0 to 2, and a+b=3. In particular, a is preferably 3, and b is preferably 0, that is, all the three substituents on the silicon atom can be R₁O.

In the general formula (1), R_{4S} each independently denote an alkylene group with 2 to 4 carbon atoms. The alkylene group with 2 to 4 carbon atoms may be an ethylene group, a n-propylene group, an i-propylene group, or a n-butylene group. In particular, an ethylene group can be used. The number of OR₄, that is, n (average value) that denotes the number of alkylene oxide groups ranges from 6 to 24. n of less than 6 results in an alkylene oxide chain with too short a length and consequently an insufficient repulsive force due to steric hindrance and an ink with low ejection stability. n of more than 24 results in an alkylene oxide chain with too long a length and consequently enhanced hydrophilicity and easy liberation in an aqueous medium. This results in an insufficient affinity for a surface hydroxy group of titanium oxide particles and aggregation of titanium oxide particles. Thus, titanium oxide particles cannot be stably dispersed, and the ink cannot have ejection stability.

In the general formula (1), X denotes a single bond or an alkylene group with 1 to 6 carbon atoms. When X denotes a single bond, it means that the silicon atom is directly bonded to OR₄. The alkylene group with 1 to 6 carbon atoms may be a methylene group, an ethylene group, a n-propylene group, an i-propylene group, a n-butylene group, a n-pentylene group, a n-hexylene group, or the like. In particular, a n-propylene group can be used. When X denotes an alkylene group with more than 6 carbon atoms, a compound represented by the general formula (1) has excessively high hydrophobicity, titanium oxide particles cannot be stably dispersed, and the ink cannot have ejection stability.

A compound represented by the general formula (1), which is a dispersant for titanium oxide particles, can be a compound represented by the following general formula (2). Having three OR_{1S} bonded to the silicon atom, a compound represented by the general formula (2) can be partially hydrolyzed in an aqueous medium and form three hydroxy groups bonded to the silicon atom, thus increasing a portion with an affinity for titanium oxide particles. A compound represented by the following general formula (2) has a repeating structure of an ethylene oxide group. Thus, the ethylene oxide chain can extend moderately in an aqueous medium, and a repulsive force due to steric hindrance can be obtained.

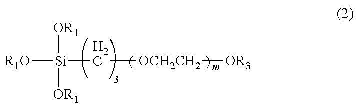

(In the general formula (2), R₁ and R₃ each independently denote a hydrogen atom or an alkyl group with 1 to 4 carbon atoms. m ranges from 8 to 24.)

The amount of compound represented by the general formula (1) (% by mass) in ink is preferably 0.002 times or more and 0.10 times or less the titanium oxide particle content (% by mass) in terms of mass ratio. A mass ratio of less than 0.002 times may result in a smaller effect of stably dispersing titanium oxide particles and an ink with insufficient ejection stability. A mass ratio of more than 0.10 times tends to result in too high a proportion of a compound represented by the general formula (1) and condensation (self-condensation) between molecules of a compound represented by the general formula (1). This may result in a compound represented by the general formula (1) consumed without acting as a dispersant, a weak action of stably dispersing titanium oxide particles, and an ink with insufficient ejection stability.

A compound represented by the general formula (1) is hydrogen-bonded to a surface hydroxy group of titanium oxide particles and is considered to partially form a covalent bond by a dehydration reaction. In the present disclosure, however, a compound represented by the general formula (1) can disperse titanium oxide particles without forming a covalent bond with the titanium oxide particles. Thus, the amount of a compound represented by the general formula (1) covalently bonded to titanium oxide particles is very small and is negligible. Thus, the titanium oxide particle content does not include a covalently bonded compound represented by the general formula (1). On the basis of study results by the present inventors, it has been found that too large an amount of a compound represented by the general formula (1) covalently bonded to titanium oxide particles results in an ink with lower ejection stability. The reason for this is considered as described below. In general, in a liquid medium with high permittivity, such as water, electrostatic attractive force is less likely to act, and titanium oxide particles move freely without significant environmental effects. When a compound represented by the general formula (1) is covalently bonded to titanium oxide particles, however, the hydrophilic portion (OR₄ portion) of the structure of the general formula (1) forms a hydrogen bond with water molecules and may consequently affect the movement of the titanium oxide particles. Thus, in a situation where liquid is deformed by an instantaneous pressure as in ink jet ejection, the characteristics as described above appear as a difference in ejection characteristics. Thus, the amount (% by mass) of a compound represented by the general formula (1) covalently bonded to titanium oxide particles is preferably 0.001 times or less the titanium oxide particle content (% by mass) in terms of mass ratio. A mass ratio of more than 0.001 times may result in an ink with insufficient ejection stability. The mass ratio may be 0.0001 times or less. The amount of a compound represented by the general formula (1) covalently bonded to titanium oxide particles can be calculated by thermogravimetric analysis or the like.

### Resin

An ink can contain a resin. The type and the range of the amount of a resin that can be used are the same as those of the resin contained in the reaction liquid described above and are not described here. The reaction liquid and the ink may contain different types of resins.

### Aqueous Medium

The ink is an aqueous ink containing water as an aqueous medium. The ink may contain water or an aqueous medium that is a mixed solvent of water and a water-soluble organic solvent. The water can be deionized water (ion-exchanged water). The water content (% by mass) of the ink is preferably 50.00% by mass or more and 95.00% by mass or less based on the total mass of the ink.

The water-soluble organic solvent is not particularly limited as long as the solvent is water-soluble (the solvent can dissolve in water at any ratio at 25° C.). More specifically, a monohydric or polyhydric alcohol, an alkylene glycol, a glycol ether, a nitrogen-containing polar compound, a sulfur-containing polar compound, or the like can be used. The water-soluble organic solvent content (% by mass) of the ink is preferably 3.00% by mass or more and 50.00% by mass or less, more preferably 10.00% by mass or more and 40.00% by mass or less, based on the total mass of the ink. A water-soluble organic solvent content (% by mass) of less than 3.00% by mass may result in solidification of the ink in an ink jet recording apparatus and insufficient sticking resistance. A water-soluble organic solvent content (% by mass) of more than 50.00% by mass may result in ink supply failure.

### Other Additive Agents

An ink may contain, in addition to the additive agents described above, other additive agents, such as a surfactant, a pH adjuster, an anticorrosive, a preservative, a fungicide, an antioxidant, a reducing inhibitor, an evaporation promoter, and/or a chelating agent, if necessary. In particular, the ink can contain a surfactant. The surfactant content (% by mass) of the ink is preferably 0.10% by mass or more and 5.00% by mass or less, more preferably 0.10% by mass or more and 2.00% by mass or less, based on the total mass of the ink. The surfactant may be an anionic surfactant, a cationic surfactant, or a nonionic surfactant. In particular, a nonionic surfactant that has a low affinity for titanium oxide particles and produces an effect even in a small amount can be used to adjust various physical properties of ink.

### Physical Properties of Ink

An ink is applied to an ink jet system and can have physical properties appropriately adjusted for the ink jet system. The ink preferably has a surface tension of 10 mN/m or more and 60 mN/m or less, more preferably 20 mN/m or more and 40 mN/m or less, at 25° C. The surface tension of the ink can be adjusted by appropriately determining the type and amount of the surfactant in the ink. The viscosity at 25° C. is preferably 1.0 mPa·s or more and 10.0 mPa·s or less. The ink preferably has a pH of 7.0 or more and 9.0 or less at 25° C. When the ink has a pH in this range, a compound represented by the general formula (1) is hydrolyzed and forms a silanol group, thus effectively exhibiting a weak affinity for titanium oxide particles. The pH of the ink can be measured with a typical pH meter equipped with a glass electrode.

### EXAMPLES

Although the present disclosure is described below in more detail in the exemplary embodiments, the present disclosure is not limited to these exemplary embodiments within the gist of the present disclosure. Unless otherwise specified, “part(s)” and “%” with respect to the amount of component are based on mass. A dispersion liquid of titanium oxide particles is referred to as a “pigment dispersion liquid”.

### <Preparation of Titanium Oxide>

Commercially available rutile titanium oxide particles subjected to a surface treatment in advance were used. The volume-based cumulative 50% particle size (D50) of titanium oxide particles was measured with a particle size analyzer utilizing the dynamic light scattering method (trade name “Nanotrac WaveII-EX150”, manufactured by MicrotracBEL Corp.). Table 1 shows characteristics of titanium oxide particles.

TABLE 1
Characteristics of titanium oxide particles

| Titanium | | | | | |
|---|---|---|---|---|---|
| oxide | | | Surface | D₅₀ | Density |
| particles | Type | Manufacturer | treatment | (nm) | (g/cm³) |
| 1 | Tipaque | Ishihara Sangyo | Alumina, | 250 | 4 |
| | PFC-211 | Kaisha, Ltd. | silica | | |
| 2 | Tipaque | Ishihara Sangyo | Alumina, | 210 | 4 |
| | CR-60-2 | Kaisha, Ltd. | silica | | |

### <Preparation of Pigment Dispersion Liquid>

### Pigment Dispersion Liquid 1

A styrene-methyl methacrylate-methacrylic acid copolymer (resin 1) with an acid value of 150 mgKOH/g and a weight-average molecular weight of 10,000 was prepared. 20.0 parts of the resin 1 was neutralized with potassium hydroxide equimolar to the acid value thereof, and an appropriate amount of pure water was added to the resin 1 to prepare an aqueous solution of the resin 1 with a resin content (solid content) of 20.0%, 40.0 parts of the titanium oxide particles 1, 40.0 parts of the aqueous solution of the resin 1, and ion-exchanged water to make a total of 100.0 parts were mixed and pre-dispersed using a homogenizer. The product was then dispersed (main dispersion) at 25° C. for 12 hours with a paint shaker using 0.5 mm zirconia beads. The zirconia beads were filtered off, and an appropriate amount of ion-exchanged water was added as necessary to prepare a pigment dispersion liquid 1 with a titanium oxide particle content of 40.0% and a resin dispersant (resin 1) content of 8.0%.

### <Preparation of Ink>

25.0 parts of the pigment dispersion liquid 1 and the following components were mixed and stirred. Pressure filtration was then performed with a membrane filter (manufactured by Sartorius) with a pore size of 5.0 μm to prepare an ink 1.

Details of the mixed components are described below.
Acrylic resin particles (trade name “Vinyblan 2685”, manufactured by Nissin Chemical Industry Co., Ltd., resin particle content: 30%): 20.0 parts
Diethylene glycol: 10.0 parts
Diethylene glycol isobutyl ether: 10.0 parts
Fluorinated surfactant (trade name “Capstone FS-3100”, manufactured by The Chemours Company): 1.0 part
Ion-exchanged water: 34.0 parts

The viscosity (Pa·s) of the ink 1 and the density (g/cm³) of the liquid component were 8 Pa-s and 1.16 g/cm³, respectively.

### <Preparation of Reaction Liquid>

The following components were mixed, sufficiently stirred, and subjected to pressure filtration through a cellulose acetate filter (manufactured by Advantec Toyo Kaisha, Ltd.) with a pore size of 3.0 μm to prepare a reaction liquid 1.
Magnesium sulfate: 2.0%
1,2-butanediol: 20.0%
Fluorinated nonionic surfactant (trade name “Capstone FS3100”, manufactured by LEHVOSS Group): 0.5%
Preservative (trade name “Proxel GXL(S)”, manufactured by Arch Chemicals, Inc.): 0.2%
Ion-exchanged water: 77.3%

When magnesium sulfate was added, magnesium sulfate heptahydrate was used in an amount corresponding to the specified amount of magnesium sulfate.

### <Liquid Ejection Head>

### Head 1

A liquid ejection head illustrated in FIGS. 2 to 13B and having the protective member 140 illustrated in FIG. 20A was prepared as a head 1. The protective member 140 was made of stainless steel.

### Head 2

A head 2 was prepared with the same configuration as the head 1 except that the head 2 did not have the protective member 140.

### <Evaluation>

The ink 1 and the reaction liquid 1 were set in an ink jet recording apparatus equipped with the head 1 or the head 2, and the ink was ejected at a temperature of 25° C. and a relative humidity of 50%. As a result, it was confirmed that the ink jet recording apparatus with the head 1 fully has the advantages of the present disclosure.

The present disclosure can provide an ink jet recording method that has high ejection stability of a reaction liquid or an ink.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-173993 filed Oct. 6, 2023, which is hereby incorporated by reference herein in its entirety.

What is claimed is:

1. An ink jet recording method for recording an image on a record medium using a liquid ejection apparatus, the method comprising:
ejecting an aqueous ink from a first ejection port; and
ejecting, from a second ejection port, an aqueous reaction liquid containing a reactant that reacts with the aqueous ink,
wherein the liquid ejection apparatus includes:
an element substrate having the second ejection port configured to eject the aqueous reaction liquid, a pressure chamber configured to supply the aqueous reaction liquid to the second ejection port, and an energy-generating element configured to generate energy to eject the aqueous reaction liquid;
an upstream channel configured to supply the aqueous reaction liquid to the pressure chamber; and
a downstream channel in communication with the pressure chamber, and the element substrate has a face configured to face the record medium in an ejection direction of the aqueous reaction liquid,
wherein the method further comprising
ejecting the aqueous reaction liquid from the second ejection port which is located closer to the pressure chamber than the face in a direction perpendicular to the face, and
flowing the aqueous reaction liquid from the upstream channel to the downstream channel through the pressure chamber.

2. The ink jet recording method according to claim 1, wherein the aqueous reaction liquid is ejected from the liquid ejection head having a distance between the face and the second ejection port in a direction perpendicular to the face being 1.0 μm or more and 50 μm or less.

3. The ink jet recording method according to claim 1, wherein the aqueous reaction liquid is ejected from the liquid ejection head having a shortest distance between the face and the second ejection port in a direction parallel to the face being 1.0 mm or less.

4. The ink jet recording method according to claim 1, wherein
the aqueous reaction liquid is ejected from the liquid ejection head having the element substrate including
a substrate having the energy-generating element on a first plane;
a channel-forming member that is provided on the first plane and forms the pressure chamber and the second ejection port; and
a protective member that is provided on the first plane having the second ejection port of the channel-forming member and has an opening to expose the second ejection port, and
the protective member has the face.

5. The ink jet recording method according to claim 4, wherein the aqueous reaction liquid is ejected from the liquid ejection head having the opening of the protective member being provided corresponding to one ejection port array of a plurality of the second ejection ports arranged.

6. The ink jet recording method according to claim 4, wherein the aqueous reaction liquid is ejected from the liquid ejection head having the opening of the protective member being provided corresponding to the second ejection port.

7. The ink jet recording method according to claim 4, wherein the aqueous reaction liquid is ejected from the substrate having the protective member which contains a metal.

8. The ink jet recording method according to claim 7, wherein the aqueous reaction liquid is ejected from the substrate having the protective member which contains stainless steel.

9. The ink jet recording method according to claim 1, wherein
the aqueous reaction liquid is ejected from the liquid ejection head having the element substrate including:
a substrate having the energy-generating element on a first plane; and
a channel-forming member that is provided on the first plane and forms the pressure chamber and the second ejection port, and
the channel-forming member has the face.

10. The ink jet recording method according to claim 9, wherein the aqueous reaction liquid is ejected from the substrate which includes the channel-forming member having a depressed portion including the ejection port on an inner side.

11. The ink jet recording method according to claim 9, wherein the aqueous reaction liquid is ejected from the substrate which includes the channel-forming member formed of a resin.

12. The ink jet recording method according to claim 4, wherein
the aqueous reaction liquid is ejected from the liquid ejection head having the element substrate including:
a plurality of individual channels each including the ejection port, the pressure chamber, and the energy-generating element;
the upstream channel configured to supply the aqueous reaction liquid to the plurality of individual channels; and
the downstream channel for outflow of the aqueous reaction liquid from the plurality of individual channels.

13. The ink jet recording method according to claim 4, further comprising circulating the aqueous reaction liquid in the pressure chamber between the pressure chamber and an outside of the pressure chamber.

14. The ink jet recording method according to claim 4, further comprising circulating the aqueous reaction liquid in the pressure chamber between the pressure chamber and an outside of the element substrate.

15. The ink jet recording method according to claim 1, wherein the aqueous reaction liquid that is ejected has a viscosity of 1.0 mPa·s or more and 10.0 mPa·s or less at 25° C.

16. The ink jet recording method according to claim 4, wherein the aqueous reaction liquid that is ejected contains a resin.

17. The ink jet recording method according to claim 4, wherein the aqueous ink that is ejected has a solid density of 10% by weight or more and 30% by weight or less.

18. The ink jet recording method according to claim 4, wherein the aqueous ink that is ejected contains titanium oxide.

19. The ink jet recording method according to claim 1, wherein the aqueous ink is ejected from the first ejection port of a liquid ejection head and the aqueous reaction liquid is ejected from the second ejection port of the liquid ejection head.

20. The ink jet recording method according to claim 1, wherein
the aqueous ink is ejected from the first ejection port of a first liquid ejection head, and the aqueous reaction liquid is ejected from the second ejection port of a second liquid ejection head.
